(19) United States
(12) Patent Application Publication
(10) Pub. No.: US 2007/0143255 A1
(43) Pub. Date: Jun. 21, 2007

(54) Method and system for delivering internet content to mobile devices

(75) Inventors: Rakesh Mathur, Saratoga, CA (US); Beerud Sheth, Los Altos, CA (US); Bradley V. Husick, Medina, WA (US)

Correspondence Address: Lawrence A. Husick;Lipton, Weinberger & Husick, 201 N. Jackson Street, Media, PA, 19063, US

(73) Assignee: Webaroo, Inc., Bellevue, WA (US)

(21) Appl. No.: 11/288,034

(22) Filed: Nov. 28, 2005

(51) Int. Cl. G06F 17/30

(52) U.S. Cl. 707/3

(57) ABSTRACT

The present invention provides methods and systems for delivering Internet-derived content to mobile devices with non-persistent connectivity. The methods include the creation of a small, high-quality, representative subset of content from the Internet, which is delivered to the mobile devices. The systems and methods allow updating of Internet-derived content present on the mobile devices. Further, the systems and methods allow delivery and updating of the Internet-derived content based on user interests. Systems and methods for enabling commercial transactions, using a device with non-persistent connectivity have been provided in the present invention.

### BACKGROUND

The invention relates, in general, to the field of Internet usage, and more specifically, to the field of accessing, browsing and searching content on the Internet, through a mobile device.

Internet is a global network that connects various networks together and enables them to share resources among themselves. Internet may be used for business related activities, educational activities, entertainment activities, communication activities and the like. Users ‘surfing’ (i.e., browsing by following hyperlinks in pages) or searching for content on the Internet (using any of the available search engines, such as Google, Yahoo!, and the like) can connect to the Internet, using an electronic device, through a wired or a wireless connectivity. Examples of electronic devices include a personal computer, a laptop, a Personal Digital Assistant (PDA), a cellular phone and other such devices known in the art. Among these devices, mobile devices, such as laptops and PDAs are gaining popularity due to their advantages of mobility and convenient usage over immobile devices like desktop PC or larger personal computers.

Conventional means of connecting mobile devices to the Internet include wireless connectivity technologies like GPRS, GSM, CDMA, WiFi, Bluetooth and the like. However, these conventional mobile networks are not ubiquitous, or high-speed or cheap. Wireless connectivity that is used for connecting mobile devices to the Internet is not available everywhere, and is not even available at all times. For example, a person traveling in a train is using Internet through a wireless connection. He may get disconnected when the train will pass through a tunnel. Similarly, a person using a wireless network in a city downtown may get disconnected from the network when the user moves away, far from the city or simply into an area of weak or no signal coverage. Further, wireless connectivity typically provides lower bandwidth to the user as compared to wired connections. Therefore, in cases where the bandwidth of the connectivity is low, it becomes difficult for the user to access bulky content available on the Internet with a reasonable speed. Moreover, Internet usage through wireless connectivity is often expensive, as it can be availed by buying a subscription for units of time or amount of information transmitted and received.

One method for allowing the user to browse or search Internet content independent of the user's connectivity is to cache Internet content onto the user's device. However, the storage available on a typical device is much less than the size of the content available on the Internet. For the cached content to be useful to the user under most scenarios, it must satisfy both the repetitive and the random user behaviors.

Users consume content in various modes, the two extremes of which are the repetitive (the local daily newspaper, the favorite website etc.) and the random (search for a new vacation spot or the latest electronic gadget). Caching content from repetitively used sources is possible on limited storage since the prioritized list of sites could be specified by the user or inferred from the usage pattern. However, in the random mode, the content that the user may want to use is neither known nor can be inferred. The only way to satisfy this requirement is by caching a representative subset of the Internet i.e. a subset that contains at least some content about every possible topic, for which there is content available on the Internet.

Therefore, there is a need for a method which can be used to create a small, high-quality, representative subset of the content available on the Internet. This subset must be representative, i.e., it must contain content about every possible topic for which content is available on the Internet. It must be small, in order to be cached on devices with limited storage. Yet, this subset must contain high-quality content, in order to maximize the relevance of results.

Furthermore, content available on the Internet is continuously changing or being updated. For example, information available at news sites, web logs, weather forecasts, shopping catalogues, and the like, keeps changing regularly. Therefore, the small, high-quality, representative subset cached on the user's device should be regularly updated by providing fresh content.

Additionally, different users have differing interests and content interesting to one user may be uninteresting to another. For example, a photographer may be interested in websites related to photography, whereas a cook may be interested in forums discussing the latest recipes. There is, therefore, a need to personalize the updates to the user's interests.

In view of the foregoing, there is a need for a method that enables the user to browse or search Internet content anytime, anywhere, independent of connectivity of the user's device to the Internet. Further, there is a need for a method that enables the user to access Internet content speedily and at lesser costs. It is also apparent that there is a need for preparing a small, high-quality, representative subset of content available on the Internet, and caching this subset on the user's device. In addition, this content cached on the user's device needs to be regularly updated. Going one step further, there is also a need to personalize the cached content on his/her device.

### SUMMARY OF THE INVENTION

In view of the deficiencies in the prior art, the system and method of the present invention delivers Internet-derived content onto a device having a non-persistent connection to the Internet. The present invention delivers Internet-derived content by creating a small, high-quality, representative subset of the Internet-derived content and caching the subset on to the device. Further, the present invention provides a system on the mobile device to access, browse and search the subset. The user can access the subset on the device without connecting to the Internet.

The system and method of the present invention updates the small, high-quality, representative subset of the Internet-derived content cached on the device by incrementally replacing some or all of the cached content during an interval when the device is connected either to the Internet or to a client system, which itself has a relatively higher total bandwidth connection to the Internet. In an embodiment of the invention, the subset may be developed and updated according to the personal interests of the user.

The various embodiments of the present invention provide the user with the advantages of ubiquity, speed and cost. The methods and systems described in the present invention enable a user of a laptop or mobile device to ubiquitously access, browse and search the Internet anytime, anywhere, independent of the connectivity of the user's device to the Internet. Further, the methods and systems of the present invention enable the user to access, browse and search Internet resources cost-effectively and at a higher speed, thus providing a better user experience. These methods and systems also deliver a high-quality user experience through an intelligent generation of the subset, which maximizes the breadth and depth of content within the limited storage capacity on the laptop or mobile device.

### BRIEF DESCRIPTION OF THE DRAWINGS

The preferred embodiments of the invention will hereinafter be described in conjunction with the appended drawings that illustrate but do not limit the invention, wherein like designations denote like elements, and in which:

FIG. 1 is a schematic representation of the user interface of a user device according to the present invention;

FIG.2 is a schematic representation of an exemplary environment in which an embodiment of the invention can be practiced;

FIG. 3 is a schematic representation of a system for delivering content elements to one or more devices, according to an embodiment of the invention;

FIG. 4 is a flowchart representing a method for delivering one or more content elements to one or more devices, according to an embodiment of the invention;

FIG. 5 is a flowchart representing a method for forming a summary, according to an embodiment of the invention;

FIG. 6 is a flowchart representing a method for forming a summary, according to another embodiment of the invention;

FIG. 7 is a flowchart representing a method for identifying and adding terms to a CoverageSet, according to an embodiment of the invention; FIG. 8 is a flowchart representing a method for identifying and adding terms to a CoverageSet, according to another embodiment of the invention;

FIG. 9 is a flowchart representing a method for identifying and adding terms to a CoverageSet, according to yet another embodiment of the invention;

FIG. 10 is a flowchart representing a method for identifying and adding concepts to a CoverageSet, according to yet another embodiment of the invention;

FIG. 11 is a flowchart representing a method for pre-processing the corpus, according to an embodiment of the invention;

FIG. 12 is a flowchart representing a method for pre-processing the corpus, according to yet another embodiment of the invention;

FIG. 13 is a flowchart representing a method for computing a CoverageRank score for a content element, according to an embodiment of the invention;

FIG. 14 is a flowchart representing a method for computing a coverage breadth score for a content element, according to an embodiment of the invention;

FIG. 15 is a flowchart representing a method for computing a coverage breadth score for a content element, according to another embodiment of the invention;

FIG. 16 is a flowchart representing a method for computing a coverage depth score for a content element, according to an embodiment of the invention;

FIG. 17 is a flowchart representing a method for computing a coverage depth score for a content element, according to another embodiment of the invention;

FIG. 18 is a schematic representation of a summarizer for forming a summary, according to an embodiment of the invention;

FIG. 19 is a schematic representation of a CoverageSet managing module, according to an embodiment of the invention;

FIG. 20 is a schematic representation of CoverageRank computing module, according to an embodiment of the invention;

FIG. 21 is a schematic representation of coverage breadth computing module, according to an embodiment of the invention;

FIG. 22 is a schematic representation of coverage depth computing module, according to an embodiment of the invention;

FIG. 23 is a schematic representation of a content block according to an embodiment of the invention;

FIGS. 24a and 24b are flowcharts representing a method for updating blocks of cached content on a device according to an embodiment of the invention;

FIG. 25 is a schematic representation of a system for creating and modifying a user profile, and creating a user-item set, according to an embodiment of the invention;

FIG. 26 is a flowchart representing a method for creating and modifying a user profile, and creating a user-item set, according to an embodiment of the invention;

FIG. 27 illustrates an exemplary environment for enabling commercial transactions by using devices without a real-time connection to a transaction server, in accordance with an embodiment of the invention; and

FIGS. 28a and 28b are flowcharts representing a method for enabling commercial transactions, using devices without a real-time connection to a transaction server, in accordance with an embodiment of the invention.

### DESCRIPTION OF PREFERRED EMBODIMENTS

For the sake of convenience, the terms used to describe the various embodiments have been defined below. It should be noted that these definitions are provided to merely aid the understanding of the descriptions, and they do not, in any way, limit the scope of the present invention.

Content Element: A content element is a file, a part of a file, or a collection of files. This is the basic unit of content that is analyzed and cached. For example, a web page is a content element.

Corpus: A large collection of content elements, stored in a temporary storage means.

Summary: A small, high-quality, representative subset of content elements selected from a corpus.

Summarization: The process of preparing a summary from a corpus. To elaborate further, the process of selecting a small, high-quality, representative subset of content elements from a large collection of content elements is called ‘summarization’.

Term: A term is a word, a phrase or a sentence.

Term meaning: A term meaning is the concept that represents the underlying semantic meaning of the term. For example, the term meaning of the terms‘apples’,‘oranges’ and ‘melons’ is ‘fruit’. The phrase ‘term meaning’ is hereinafter referred to as a ‘concept’.

Alternatively, term meaning may be a node in a semantic network, such as Princeton WordNet, or the like, which represents a unique meaning of a set of one or more terms. For example, the term ‘fly’ may have a plurality of term meanings, comprising a type of insect, a hit baseball, a verb meaning to travel while airborne, and an adjective meaning—very acceptable or stylish.

Item: An item is a term or a concept.

Coverage: A content element is said to be ‘covering’ an item if the item is occurring, or is being referred to in a meaningful way, in the content element. Different content elements may cover the same item to varying degrees; therefore, the definition of coverage may vary in different embodiments. In an embodiment of the invention, an item occurring in a content element is considered to be covered by the content element. In another embodiment of the invention, an item occurring with a specific meaning or context is considered to be covered by the content element. In yet another embodiment of the invention, an item that occurs in a content element for a pre-defined number of times is considered to be covered by the content element.

CoverageSet: A set of items that are to be covered by the summary. To elaborate further, for each item that is present in the CoverageSet, there will be at least one content element in the summary, covering that item. The CoverageSet may be continually updated at every iteration step of the summarization process, such that items covered in an iteration step may be removed from the CoverageSet in that iteration step.

Item weight or Item weighing: Each item in the CoverageSet may be associated with an item weight. An item weight may be a decimal number indicating the importance of the item with respect to the other items contained in the CoverageSet.

Coverage breadth score: A coverage breadth score, computed for a content element, provides a measure of the number of items in the CoverageSet that are covered by the content element.

Coverage depth score: A coverage depth score, computed for a content element, provides a measure of the extent of coverage of items in the CoverageSet. As mentioned above, different documents cover items to varying degrees, which will be reflected in the coverage depth score.

Element-characteristic score: An element-characteristic score, computed for a content element, provides a measure of suitability for use in a disconnected environment. For example, a content element with self-contained content, which does not refer to other content elements, is more suitable for browsing on a mobile device that may be disconnected often. An example of an element characteristic score is the degree of independence of a content element, the degree of independence being the number of outlinks in the content element. An outlink is defined as a hyperlink referring to a content element other than the content element for which the element-characteristic score is being computed. If the content element has a low number of outlinks, it will have a higher degree of independence, and in turn, will have a high element-characteristic score. Another example of an element-characteristic score is the size of a content element. Clearly, content elements that are small in size are preferred for caching on a mobile device due to storage limitations.

Element importance score: An element importance score provides a measure of importance to a content element. For example, a content element that is being referred to by a large number of other content elements will have a high element importance score compared to content elements being referred to by a small number of other content elements.

CoverageRank score: A CoverageRank score is a composite value derived from various parameters that characterize a content element, such as, a coverage depth score, a coverage breadth score, an element-characteristic score, an element importance score, and subjective criteria. The CoverageRank score for a content element indicates the overall suitability of the content element for inclusion in a summary obtained by the summarization process. The CoverageRank score performs the central and critical role of balancing the size, quality and representative characteristics of the cached content. In an embodiment of the invention, a content element with a high CoverageRank score is more suitable to be included in a summary by the summarization process.

Multiple-coverage value: For certain items, it is desired that more than one content element should be present in the summary. For such items, an associated multiple-coverage value is assigned. The multiple-coverage value associated with an item specifies the minimum number of content elements covering the item that should be present in the summary.

Maximum coverage value: Certain items may have a maximum coverage value associated with them. For an item with maximum coverage value, the content element(s) that cover the item to the maximum depth are selected for inclusion in the summary.

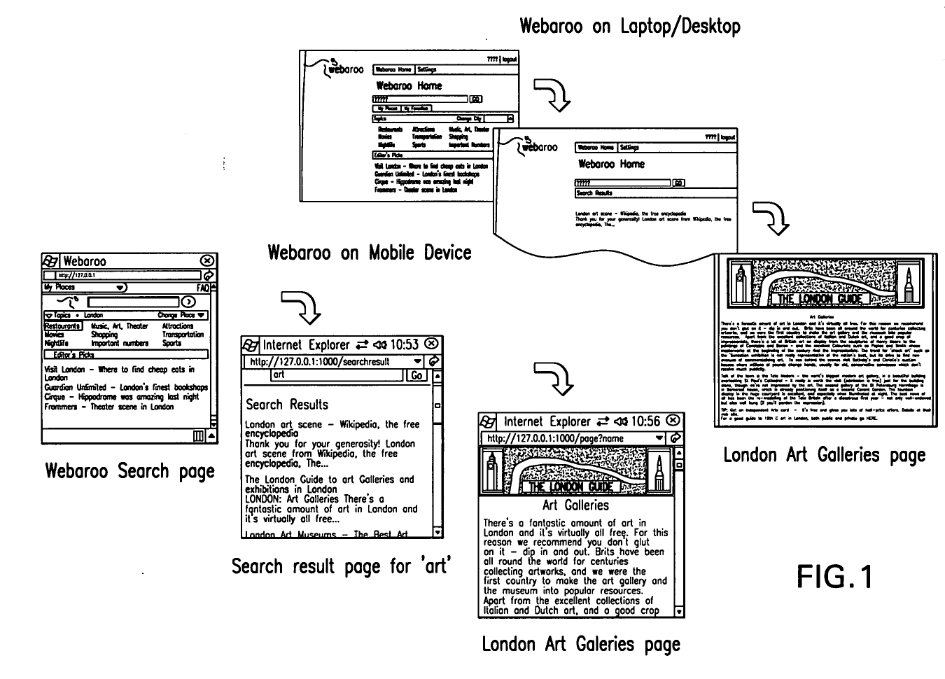

FIG. 1 is a schematic representation of the user interface of a user device according to the present invention.

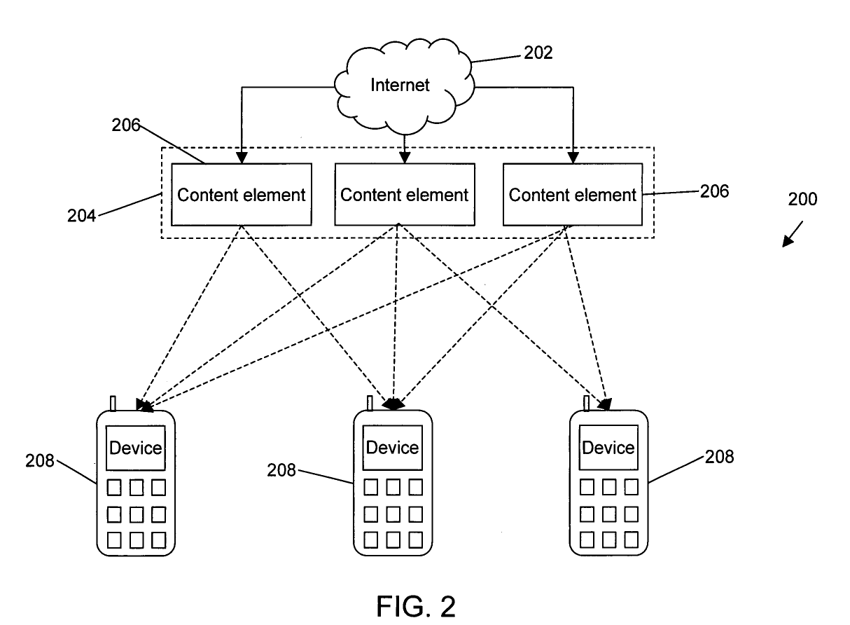

FIG. 2 is a schematic representation of an exemplary environment 200 in which an embodiment of the invention can be practiced. Environment 200 comprises Internet 202, summary 204 comprising content elements 206, and devices 208.

Each content element 206 may be a file, a part of a file, or a collection of files, obtained from various sources. Examples of files include, but are not limited to, web pages, documents, image files, video files, sound files, and the like. In an embodiment of the invention, the various sources from which content elements 206 are obtained include Internet 202. In another embodiment of the invention, the various sources from which content elements 206 are obtained include the intranet of an organization, not accessible publicly on Internet 202.

Each device 208 is an electronic device having a non-persistent connectivity with the various sources from which content elements 206 are obtained. Further, each device 208 comprises means for caching summary 204 and means for enabling a user to access, browse, or search summary 204 cached on device 208.

Examples of device 208 include, but are not limited to, a mobile phone, a smart phone, a Personal Digital Assistant (PDA), a laptop, a personal computer, and other such devices known in the art.

A device is said to have non-persistent connectivity, when user experience while accessing, browsing, or searching content elements may not be satisfactory. The unsatisfactory user experience may be caused by a slow, intermittent, or expensive network link between the device and the various sources. An example of a device having non-persistent connectivity may be a mobile phone with a slow wireless network link with the Internet. Another example of a device having non-persistent connectivity may be a PDA with a high-bandwidth, but a relatively expensive connection to the Internet. Yet another example of a device having non-persistent connectivity may be a laptop with a wireless network link with the intranet of an organization, wherein establishing the wireless network link is possible only from specially-designated areas within the organization.

Examples of network links include, but are not limited to, an infrared communication link, a Bluetooth communication link, a WiFi communication link, a USB link, and other such communication links known in the art.

Examples of means for caching contained in device 208 include, but are not limited to, a hard disk drive, a special folder on a hard disk drive, a special file on a hard disk drive, a flash drive, and other such caches known in the art.

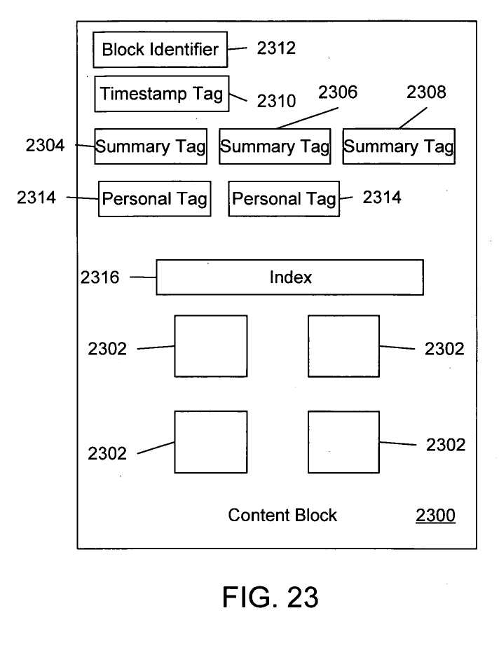

The means for accessing or browsing content elements 206 within summary 204 cached on device 208 may be web-browser software stored in device 208. The means for searching content elements 206 within summary 204 may be special software. This special software may include components such as a local web server, a search engine, and user-interface elements. The search engine is capable of parsing the query specified by the user and searching an index for relevant items, the index has been described in detail in conjunction with FIG. 23. In an embodiment of the invention, the special software may be Webaroo client software. It will be apparent to a person skilled in the art that there may be other means for accessing or browsing, and means for searching content within summary 204 cached in device 208.

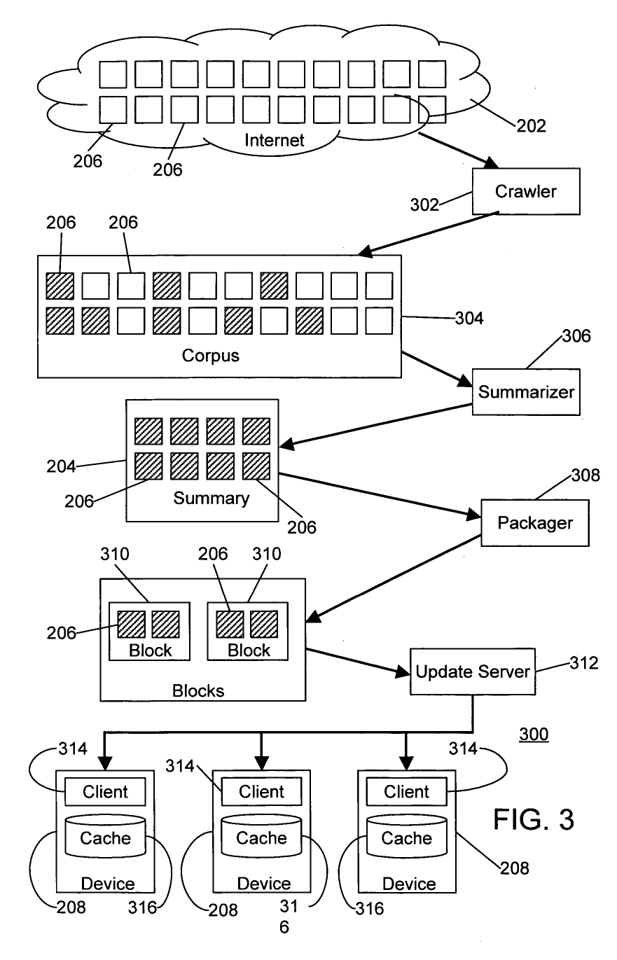

FIG. 3 is a schematic representation of a system 300 for delivering summary 204 to one or more devices 208, according to an embodiment of the invention. System 300 includes a crawler 302, a corpus 304, a summarizer 306, one or more summaries 204, packager 308, one or more blocks 310, one or more update servers 312, and one or more devices 208. Corpus 304 and summary 204 comprise content elements 206. Each device 208 includes a client 314 and a cache 316. Cache 316 includes summary 204.

Crawler 302 is a means for traversing the Internet and copying onto temporary storage means; summarizer 306 is a means for analyzing the copied content; and update server 312 is a means for delivering selected content.

Crawler 302 retrieves content elements 206 from the various sources and stores them in a temporary storage means to form corpus 304. Examples of crawler 302 are well-known in the art. Examples of temporary storage means for corpus 304 include, but are not limited to, a hard disk, a data server, a flash drive, and other such devices known in the art.

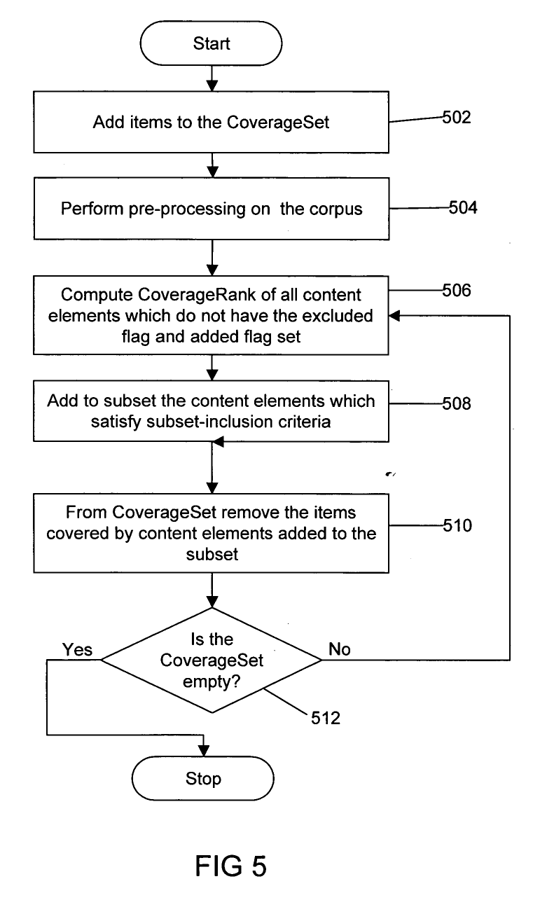

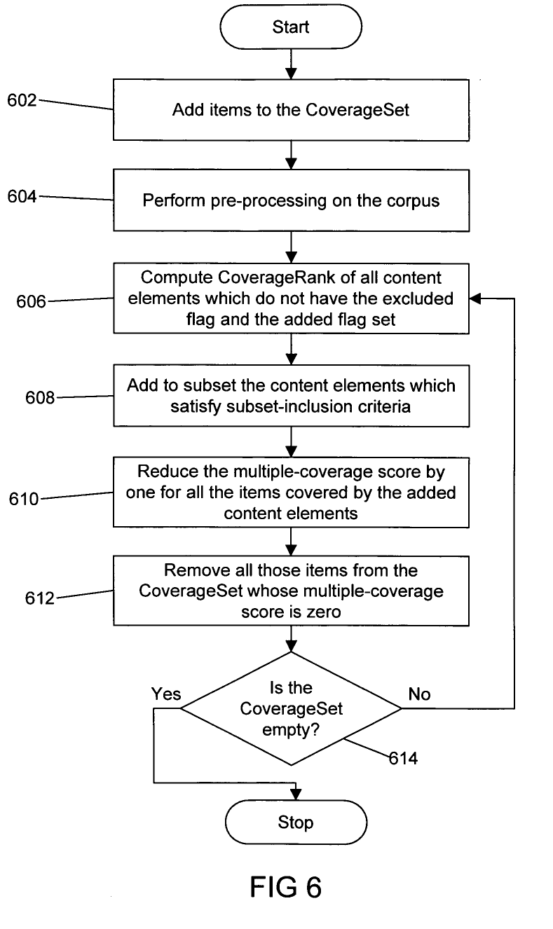

Summarizer 306 analyzes content elements 206 stored in corpus 304. Based on a set of pre-defined criteria, summarizer 306 selects a small, high-quality, representative subset of content elements 206 from corpus 304 to form summary 204. In an embodiment of the invention, summarizer 306 may form one or more small, high-quality, representative subsets to form one or more summaries 204. Embodiments of methods for forming a small, high-quality, representative subset of content elements have been described in detail, in conjunction with FIGS. 5 and 6.

Thereafter, packager 308 packages one or more summaries 206 to form one or more blocks 310. The method of packaging a summary to form a block has been described in conjunction with FIG. 23.

Thereafter, one or more update servers 312 deliver summary 204 in the form of blocks 310, to one or more clients 314. Further, one or more update servers 312 also perform the function of regularly providing updated summaries 204 to one or more clients 314.

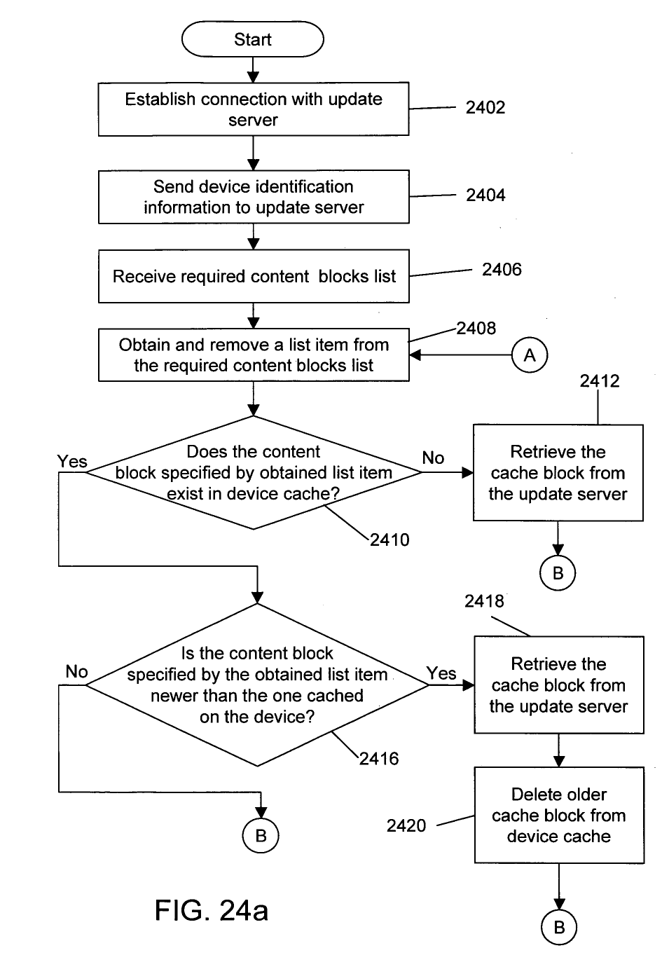

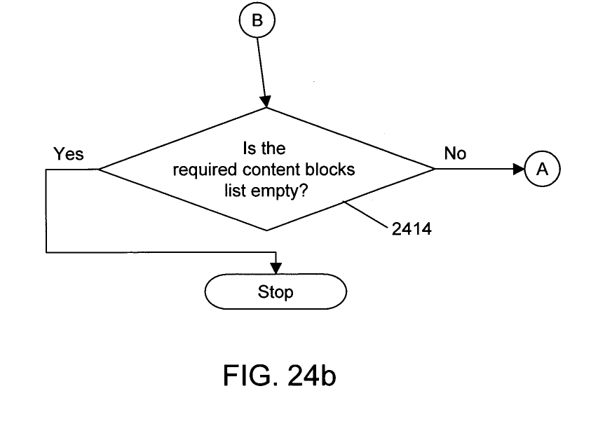

Client 314 is a software module that is present in device 206. Client 314 downloads summary 204, from one or more update servers 312, to update the summary cached on device 208, at pre-defined time intervals, or whenever a user of device 208 requests for an update. Further, client 314 is capable of downloading content elements 206 from one or more clients 314, to update the summary cached on device 208. Each client 314 is also capable of providing updated summary 204, obtained from one or more update servers 312, to other clients 314. Further, each client 314 manages summary 204 cached on device 208. Embodiments for updating a summary cached on a device have been described in detail in conjunction with FIGS. 23, 24a and 24b.

In an exemplary situation, one or more update servers deliver the summary to a user's personal computer that includes a client. The user can then update the summary cached on a mobile device, which includes another client, from the client on the personal computer. The process of updating includes retrieving the summary, in the form of content blocks, from the personal computer to the mobile device. The bandwidth of the network link between the one or more update servers and the personal computer may be greater than or equal to the bandwidth of the network link between the one or more update servers and the mobile device. The bandwidth is defined as the total amount of information received and transmitted between two consecutive updates of content elements.

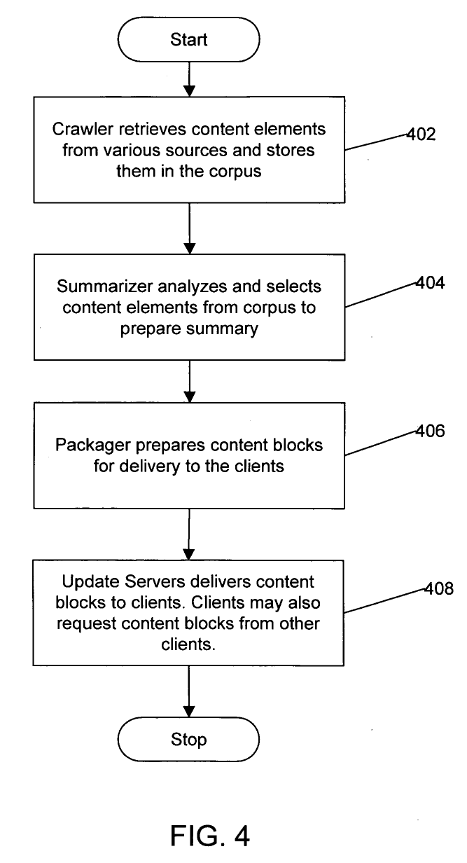

FIG. 4 is a flowchart that represents a method for delivering a summary to one or more devices, in accordance with an embodiment of the invention. This summary is prepared for a user of a device who has non-persistent network connectivity with various sources from which content elements are obtained. At step 402, a crawler retrieves one or more content elements from various sources and stores them in a temporary storage means to form a corpus of content elements. At step 404, a summarizer performs a summarization process by analyzing the one or more content elements stored in the corpus, and selects a small, high-quality, representative subset of content elements to form a summary. At step 406, a packager prepares the summary for delivery to the clients by forming content blocks. At step 408, an update server delivers the summary, in the form of content blocks, to one or more clients residing on one or more corresponding devices.

At the beginning of the summarization process, a CoverageSet is formed. The summary is selected in such a way that for each item in the CoverageSet there is at least one content element in the summary covering each item. Therefore, for a given corpus of content elements, a summary is formed with respect to a given CoverageSet. If the items contained in the CoverageSet change, the summary obtained by the summarization process may also change.

In a preferred embodiment of the invention, the summarization process comprises an iterative loop, wherein at each iteration, a CoverageRank score for all the content elements in the corpus is computed. Based on a set of pre-defined membership criteria, certain content elements are added to the summary. If required, the items that are covered by the content elements are removed from the CoverageSet. The summarization process is completed when the CoverageSet is empty. A step for pre-processing the corpus is performed before the iterative loop. It will be apparent to anyone skilled in the art that algorithms other than the iterative one described above may be employed to develop a small, high-quality, representative subset.

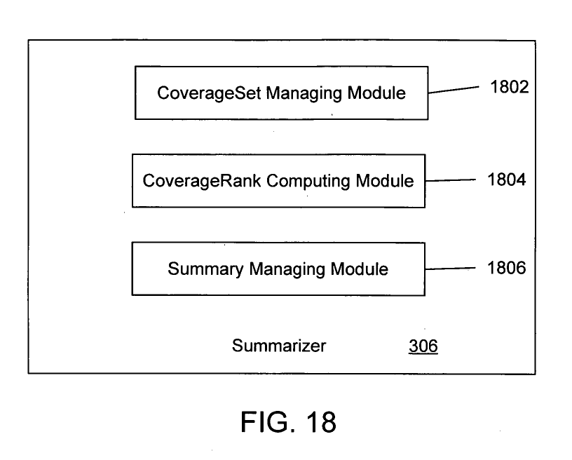

FIGS. 5 to 17 are flowcharts representing the summarization process. FIGS. 18 to 22 are system diagrams representing the system components that may be employed to perform the summarization process.

FIG. 5 is a flowchart representing a method for forming a summary, according to an embodiment of the invention. In an embodiment of the invention, multiple summaries, each covering different CoverageSets, may be prepared from the same corpus. Each content element in the corpus is associated with an ‘added flag’ and an ‘excluded flag’. The added flag indicates whether the content element has been added to the summary or not. The excluded flag indicates whether the content element has been forbidden from being included in the summary or not. During the summarization process these flags are used to determine whether a content element should be considered for inclusion in the summary or not. The added flags and excluded flags associated with all the content elements are cleared before a summarization process begins.

The method essentially comprises an iterative loop, wherein at each iteration, content elements are added to the summary, based on a set of pre-defined summary- inclusion criteria. Items that are covered by these content elements are removed from the CoverageSet. The iterations continue until the CoverageSet is empty.

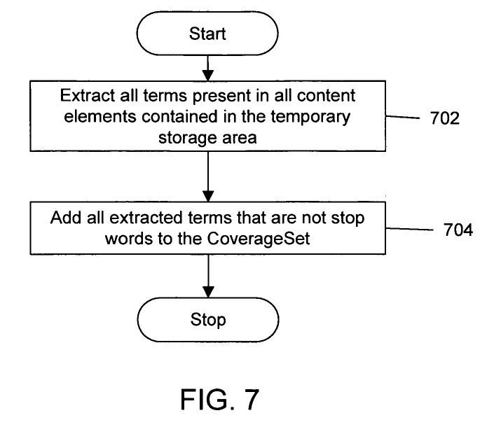

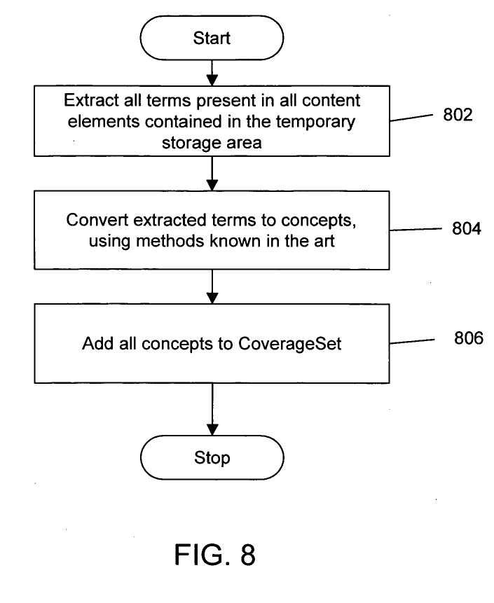

At step 502, items to be included in the CoverageSet are identified and added to the CoverageSet. Embodiments for identifying and adding items to the CoverageSet have been described in detail in conjunction with FIGS. 7, and 8.

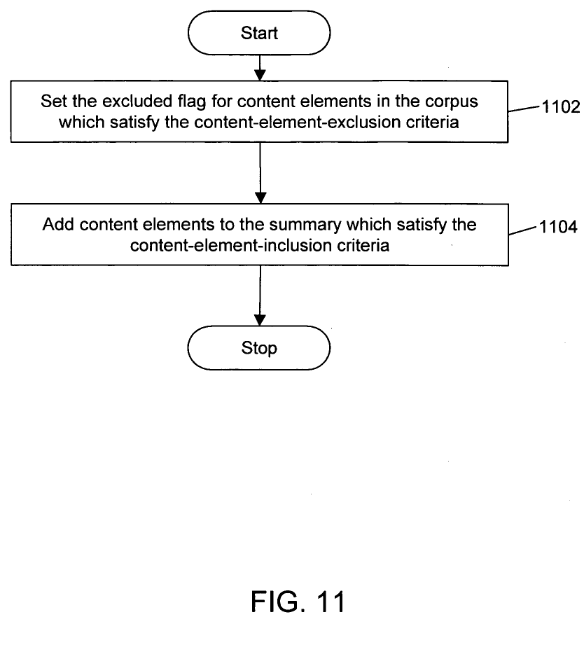

At step 504, content elements stored in the corpus are pre-processed to add certain content elements to the summary. An embodiment for pre-processing the corpus has been described in detail in conjunction with FIG. 11.

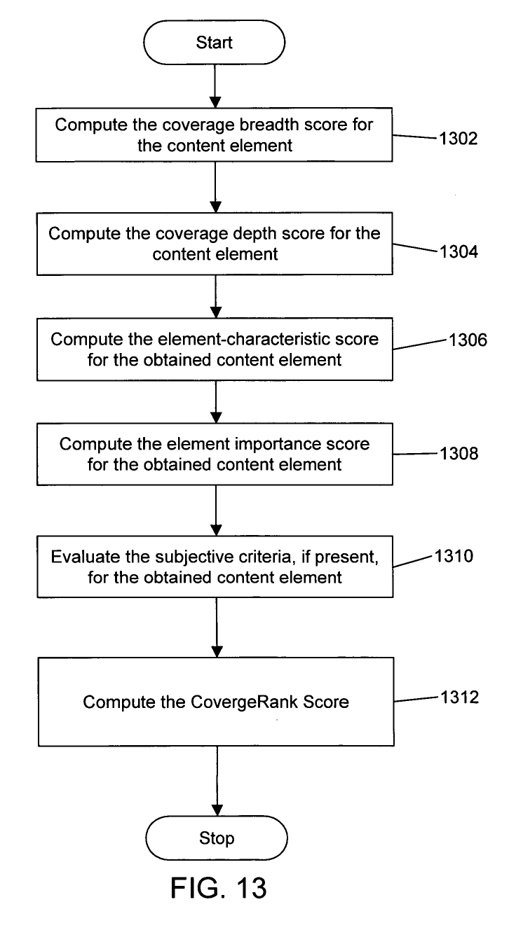

At step 506, a CoverageRank score for each content element in the corpus that does not have an added or an excluded flag, is computed. An embodiment for computing the CoverageRank score for a content element has been described in detail in conjunction with FIG. 13.

At step 508, all content elements satisfying the pre-defined summary-inclusion criteria are added to the summary. The step of adding a content element to the summary includes setting the added flag associated with the content element.

In an embodiment of the invention, a summary-inclusion criterion may be to include the content element with the highest CoverageRank score. In another embodiment of the invention, a summary inclusion criterion may be to include content elements with a CoverageRank score greater than a pre-defined threshold value. However, it will be apparent to a person skilled in the art that other relevant summary-inclusion criteria may be employed for selecting content elements to form the summary.

At step 510, items covered by the content elements added to the summary in step 508 are removed from the CoverageSet. At step 512, it is checked whether the CoverageSet is empty. If, at step 512, it is discovered that the CoverageSet is not empty, steps 506, 508, 510, and 512 are performed iteratively as a part of the loop, until the CoverageSet is empty. If, at step 512, the CoverageSet is empty, the iterative loop is terminated and the formation of the summary is complete.

FIG. 6 is a flowchart representing a method for forming a summary, according to another embodiment of the invention. The key difference from FIG. 5 is that the items in the CoverageSet in FIG. 6 need multiple coverage. The method comprises an iterative loop, wherein at each iteration, content elements present in the corpus are added to the summary based on a set of pre-defined summary-inclusion criteria, multiple coverage values of items covered by those content elements are reduced by one, and items with multiple coverage values of zero are removed from a CoverageSet. The iteration is continued until the CoverageSet is empty. A step for pre-processing the corpus is performed before the iterative loop.

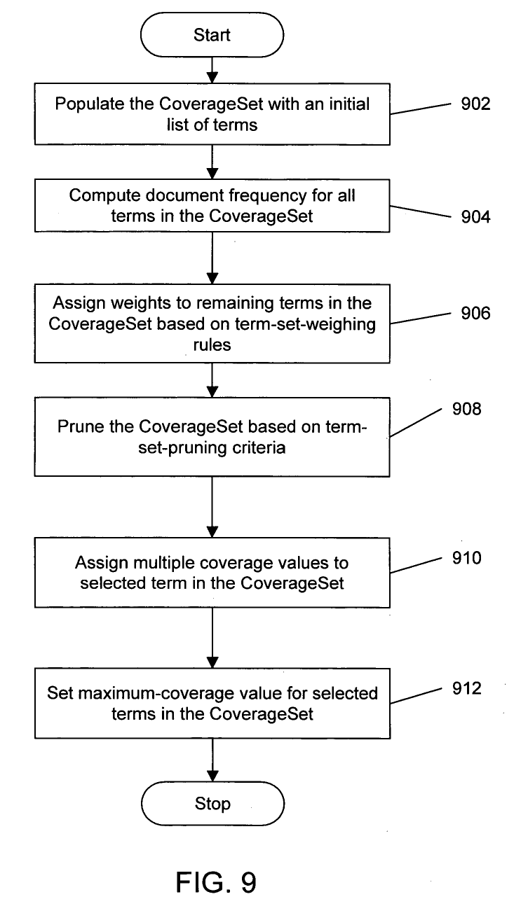

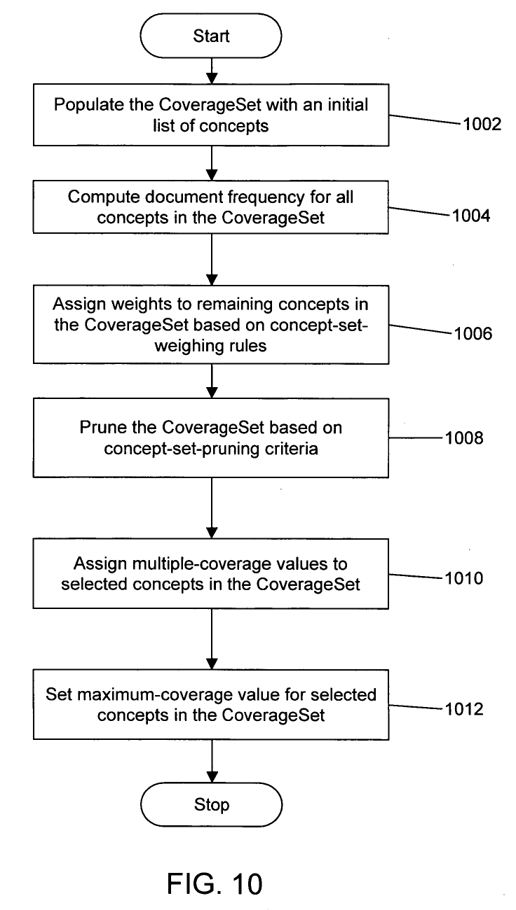

At step 602, items to be included in the CoverageSet are identified and added to the CoverageSet. Embodiments for identifying and adding items, wherein each item is associated with a multiple coverage value, to the CoverageSet have been described in detail in conjunction with FIGS. 9 and 10.

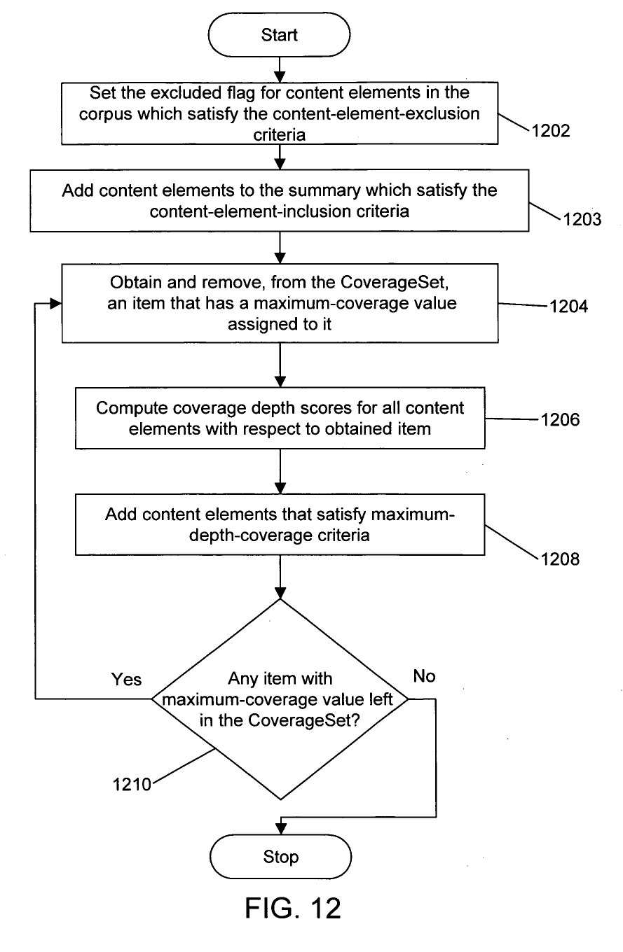

At step 506, content elements stored in the corpus are pre-processed to add certain content elements to the summary. An embodiment for pre-processing the corpus has been described in detail in conjunction with FIG. 12.

At step 606, a CoverageRank score is computed for each content element in the corpus that does not have an added or an excluded flag. An embodiment for computing the CoverageRank score for a content element has been described in detail in conjunction with FIG. 13.

At step 608, all content elements satisfying the set of pre-defined summary-inclusion criteria are added to the summary. The step of adding a content element to the summary includes setting the added flag associated with the content element.

At step 610, a multiple coverage value associated with each item covered by the content elements, added to the summary at step 608, is reduced by one. Embodiments for forming a CoverageSet, wherein each item is associated with a multiple-coverage value, have been described in detail in conjunction with FIGS. 9 and 10.

At step 612, all items in the CoverageSet whose corresponding multiple-coverage values are zero, are removed from the CoverageSet. At step 614, it is checked whether the CoverageSet is empty. If, at step 614, the CoverageSet is not empty, steps 606, 608, 610, 612, and 614 are performed iteratively as a part of the loop, until the CoverageSet is empty. If, at step 614, the CoverageSet is empty, the loop is terminated and formation of the summary is complete.

Step 502 of FIG. 5 has been described in detail in conjunction with FIG. 7. An alternative embodiment of step 502 has been described in detail in conjunction with FIG. 8.

FIG. 7 is a flowchart representing a method for identifying and adding terms to the CoverageSet, according to an embodiment of the invention. At step 702, all terms present in all content elements in the corpus are extracted. At step 704, the terms extracted in step 702 that are not ‘stop words’ are added to the CoverageSet. Stop words are words that occur frequently in a language but have a low-information value, for example, ‘a’, ‘the’, ‘in’, ‘as’, on’, and the like.

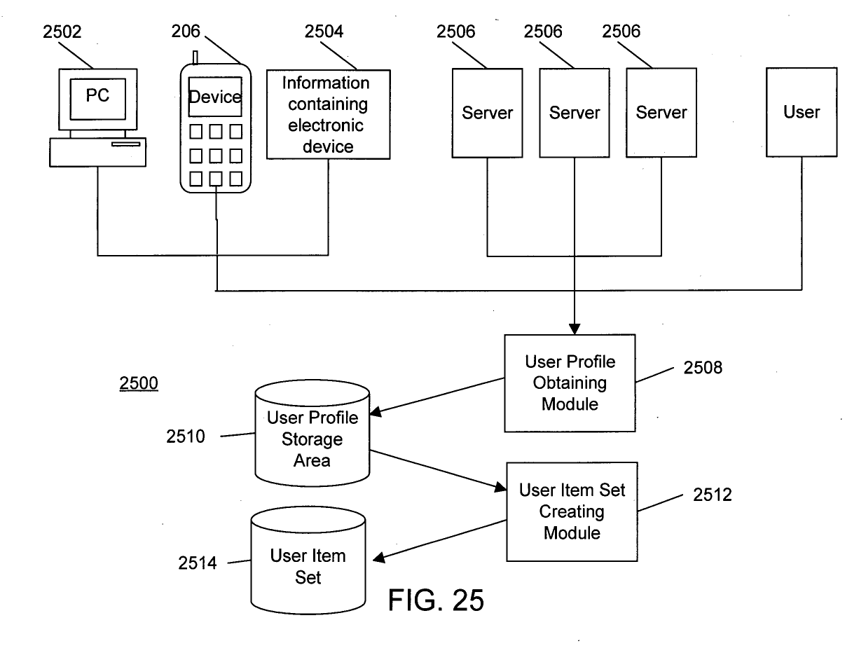

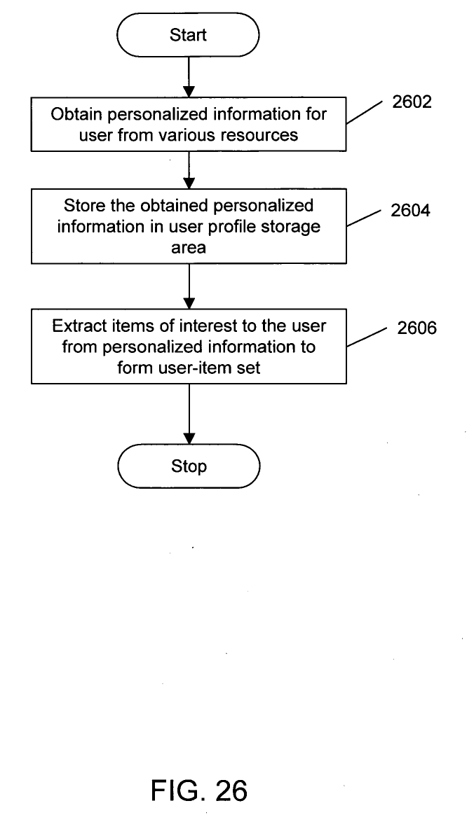

In an embodiment of the invention, terms present in a user-item set are also added to the CoverageSet. A user-item set contains items of interest to a user. Embodiments for preparing a user-item set have been described in detail in conjunction with FIGS. 25 and 26.

FIG. 8 is a flowchart representing a method for identifying and adding terms to the CoverageSet, according to another embodiment of the invention. At step 802, all terms present in all content elements in the corpus are extracted. At step 804, the terms extracted in step 802 are mapped onto one or more concepts by using methods known in the art. At step 806, all the concepts to which terms have been mapped in step 802, are added to the CoverageSet.

In an embodiment of the invention, concepts present in a user-item set are also added to the CoverageSet. Embodiments for preparing a user-item set have been described in detail in conjunction with FIGS. 25 and 26.

Step 602 of FIG. 6 has been described in detail in conjunction with FIG. 9. An alternative embodiment of step 602 has been described in detail in conjunction with FIG. 10.

FIG. 9 is a flowchart representing a method for identifying and adding terms to the CoverageSet, according to yet another embodiment of the invention. At step 902, the CoverageSet is populated with an initial list of terms. In an embodiment of the invention, the CoverageSet is populated with an initial list of terms by using the method described in FIG. 7. In another embodiment of the invention, the CoverageSet is populated with a list of terms specified by editors. At step 904, a document frequency for each term in the CoverageSet is computed. The document frequency for a term is computed as the number of content elements in which the term occurs.

At step 906, each term in the CoverageSet is assigned a weight according to a set of pre-defined term set-weighing rules. In an embodiment of the invention, a term- set-weighing rule is the assigning of a term a weight equal to its inverse document frequency. Methods of computing the inverse document frequency for a term are well- known in the art. One such method for computing the inverse document frequency for a term is computing the logarithm of the ratio of the total number of content elements in the corpus to the number of content elements in which the term occurs.

In another embodiment of the invention, a term set-weighing rule is, assigning higher weights to terms contained in a domain-specific dictionary than terms not contained in the dictionary. Examples of domain-specific dictionaries include, but or not limited to, a dictionary containing terms related to the field of medical science, a dictionary containing terms related to the field of computer science, a dictionary containing terms related to the field of history, and the like. The domain-specific dictionaries may be related to a pre-determined knowledge domain of interest to a particular user. However, the domain-specific dictionaries may be related to sources other than the knowledge domain of interest to the user.

In yet another embodiment of the invention, a term set-weighing-rule is assigning weights to terms as specified by editors. Editors may assign weights to terms manually before the summarization process starts.

In still another embodiment of the invention, a term set-weighing-rule is, assigning higher weights to terms occurring in a user-item set, than terms not occurring in the user-item set. Embodiments for preparing a user-item set have been described in detail in conjunction with FIGS. 25 and 26.

At step 908, all terms in the CoverageSet that satisfy a set of pre-defined term- set-pruning criteria are removed from the CoverageSet. Terms which satisfy the pre-defined term set-pruning criteria may be considered to have a lower-information value than the terms not satisfying the pre-defined term set-pruning criteria. In an embodiment of the invention, a term set-pruning-criterion may be to remove terms with a document frequency less than a pre-defined MinDocs threshold value. In another embodiment of the invention, a term set-pruning criterion may be to remove terms with term weights below a pre-defined threshold value. In another embodiment of the invention, a term set-pruning criterion may be to remove terms not belonging to a specific domain. In yet another embodiment of the invention, a term set-pruning criterion may be to remove terms specified by editors.

At step 910, each term in the CoverageSet is assigned a multiple-coverage value. The multiple-coverage value for a term specifies the minimum number of content elements covering the term that should be included in the summary. For example, a term with a multiple-coverage value of six should be covered by at least six content elements included in the summary.

At step 912, a maximum coverage value is set for selected terms contained in the CoverageSet. Setting the maximum coverage value for a particular term would indicate that content elements with the highest coverage depth with respect to that term are included in the summary.

FIG. 10 is a flowchart representing a method for identifying and adding concepts to the CoverageSet, according to yet another embodiment of the invention. At step 1002, the CoverageSet is populated with an initial list of concepts. In an embodiment of the invention, the CoverageSet may be populated with an initial list of concepts, using the method described in conjunction with FIG. 8. In another embodiment of the invention, the CoverageSet is populated with a list of concepts specified by editors.

At step 1004, a document frequency for each concept is computed. In an embodiment of the invention, the document frequency for a concept is computed as the number of content elements in which the concept occurs. The number of content elements in which the concept occurs is determined by counting the number of content elements in which one or more terms, mapping onto the concept, occur. For example, consider four content elements containing the following terms:
cricket, hockey, orange;
football, basketball, grapes;
hockey, grapes, oranges;
and basketball, hockey, baseball.
   Consider the concept ‘fruits’ to which the terms ‘orange’ and ‘grapes’ map; and a concept ‘sports’ to which the terms ‘hockey’, ‘football’, ‘cricket’, ‘basketball’, and ‘baseball’ map. The number of content elements containing the concept ‘fruits’ would be two, and the number of content elements containing the concept ‘sports’ would be five.

At step 1006, each concept in the CoverageSet is assigned a weight, depending upon a set of pre-defined concept-set-weighing rules. In an embodiment of the invention, a concept-set-weighing rule may be to assign each concept a weight equal to its inverse document frequency. In another embodiment of the invention, a concept- set-weighing rule may be to assign higher concept weights to concepts contained in a domain-specific dictionary, than concepts not contained in the dictionary. In yet another embodiment of the invention, a concept-set-weighing rule may be to assign weights to concepts as specified by editors. The editors may assign weights manually to the concepts before the summarization process starts. In still another embodiment of the invention, a concept-set-weighing rule may be to assign higher weights to concepts contained in a user-item set, than concepts not contained in the user-item set.

At step 1008, all concepts satisfying a set of pre-defined concept-set-pruning- criteria are removed from the CoverageSet. In an embodiment of the invention, a concept-set-pruning criterion may be to remove concepts with a document frequency less than a pre-defined threshold value. In another embodiment of the invention, a concept-set-pruning criterion may be to remove concepts with weights below a pre-defined threshold value. In yet another embodiment of the invention, a concept-set-pruning criterion may be to remove concepts not belonging to a specific domain. Many methods are known in the art for determining whether a concept belongs to a certain domain or not. In yet another embodiment of the invention, a concept-set-pruning criterion may be to remove concepts specified by editors.

At step 1010, each concept in the CoverageSet is assigned a multiple-coverage value. This multiple-coverage value for a concept specifies the minimum number of content elements covering the concept, which should be included in the summary.

At step 1012, a maximum coverage value is assigned for selected concepts contained in the CoverageSet. Assigning a maximum coverage value for a particular concept would indicate that content elements with a greater depth should be included in the summary.

Step 504 of FIG. 5 is described in detail in conjunction with FIG. 11. Step 604 of FIG. 6 is described in detail in conjunction with FIG. 12.

FIG. 11 is a flowchart that represents a method for pre-processing the corpus, according to an embodiment of the invention. At step 1102, an excluded flag is set for all the content elements in the corpus, which satisfy a set of content-element-exclusion criteria. Each content element in the corpus is associated with an excluded flag, which determines whether the content element has been forbidden from being included in the summary. In an embodiment of the invention, a content-element-exclusion criterion may be to exclude content elements specified by editors. In another embodiment of the invention, a content-element-exclusion criterion may be to exclude content elements obtained from objectionable websites, such as, pornographic websites.

At step 1104, content elements that satisfy a set of content-element-inclusion criteria are added to the summary. The step of adding a content element to the summary includes setting the added flag associated with that content element. In an embodiment of the invention, a content element-inclusion-criterion may be to include content elements specified by editors.

FIG. 12 is a flowchart that represents a method for pre-processing the corpus, according to another embodiment of the invention. At step 1202, an excluded flag is set for all the content elements in the corpus, which satisfy a set of content-element-exclusion criteria.

At step 1203, content elements that satisfy a set of content-element-inclusion criteria are added to the summary. The step of adding a content element to the summary includes setting the added flag associated with that content element. In an embodiment of the invention, a content-element-inclusion criterion may be to include content elements specified by editors.

At step 1204, an item that has a maximum-coverage value associated with it is obtained and removed from the CoverageSet.

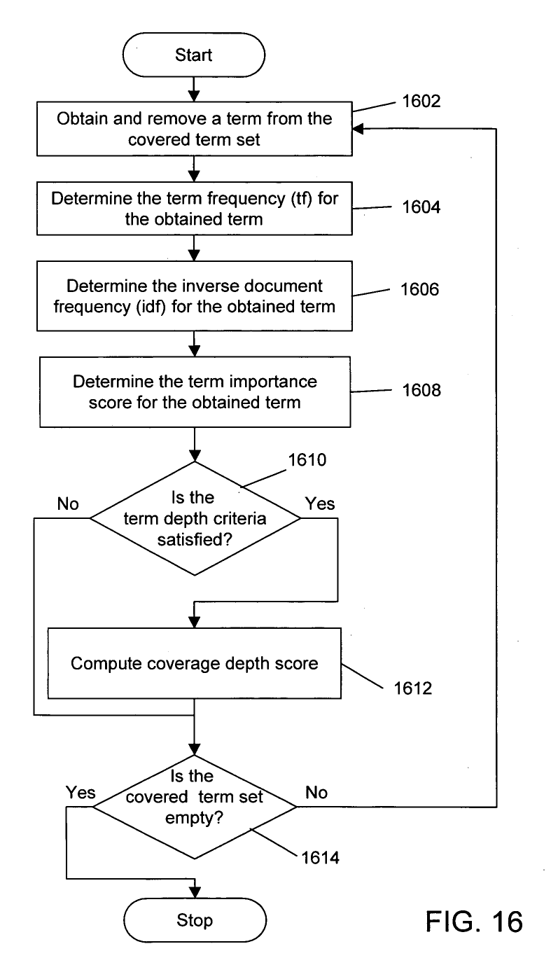

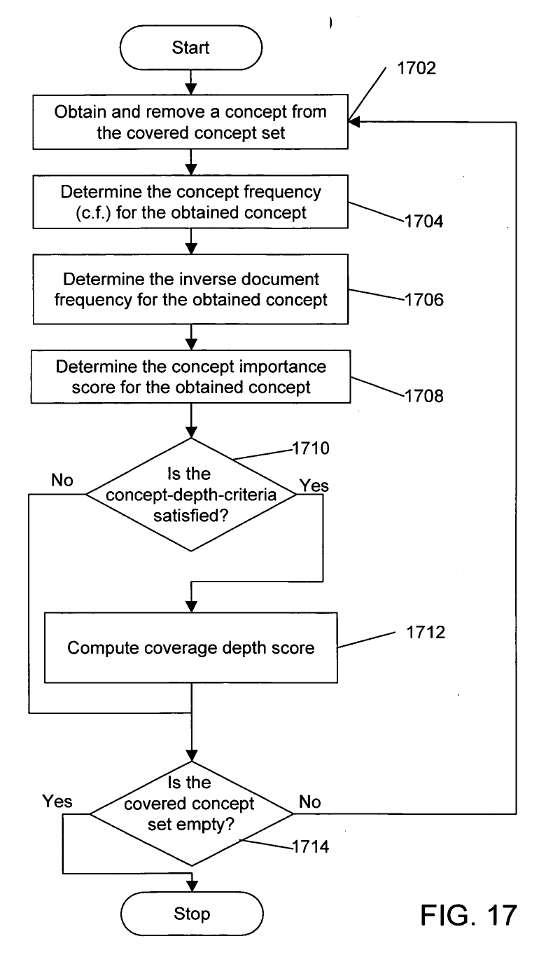

At step 1206, coverage depth scores are computed for all content elements in the corpus, with respect to all those items in the CoverageSet, which have a maximum-coverage value assigned to them. In an embodiment of the invention, a coverage depth score for a content element with respect to an item is defined as the product of the frequency of occurrence of that item in the content element and the inverse document frequency of that item. The concept of a coverage depth score has been described in detail in conjunction with FIGS. 16 and 17.

At step 1208, content elements satisfying a set of maximum depth coverage criteria are added to the summary. The step of adding a content element to the summary includes setting the added flag associated with that content element. In an embodiment of the invention, a maximum coverage depth criterion may be to add the content element, which has the maximum coverage depth score. In another embodiment of the invention, a maximum-coverage-depth criterion may be to add content elements with the top N coverage depth scores, where N is the multiple coverage value associated with the obtained item.

At step 1210, it is checked whether any items with a maximum-coverage value associated with them are present in the CoverageSet. If such items are present, steps 1204, 1206, 1208, and 1210 are performed as part of an iterative loop. If, at step 1210, such items are not present in the CoverageSet, the iterative loop is terminated and the pre-processing of the corpus is complete.

Step 506 of FIG. 5 has been described in detail in conjunction with FIG. 13.

FIG. 13 is a flowchart that represents a method for computing a CoverageRank score for a content element, according to an embodiment of the invention.

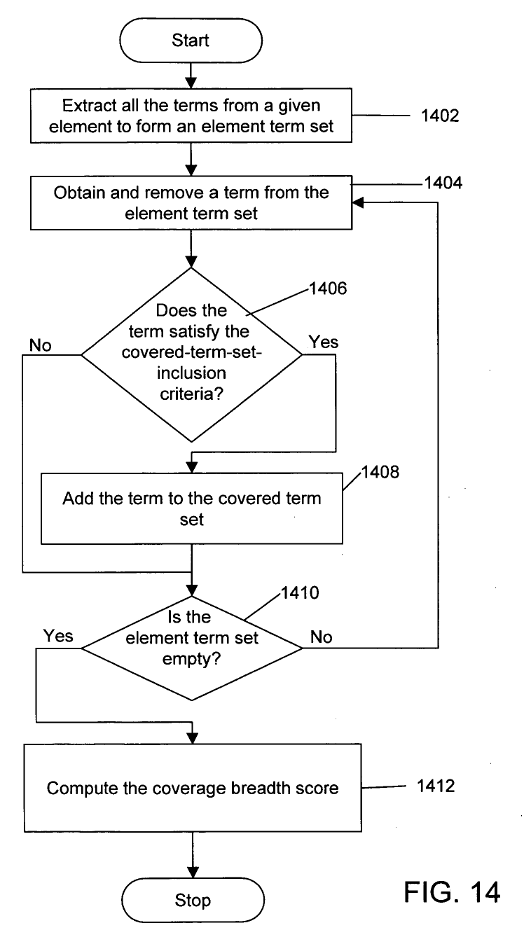

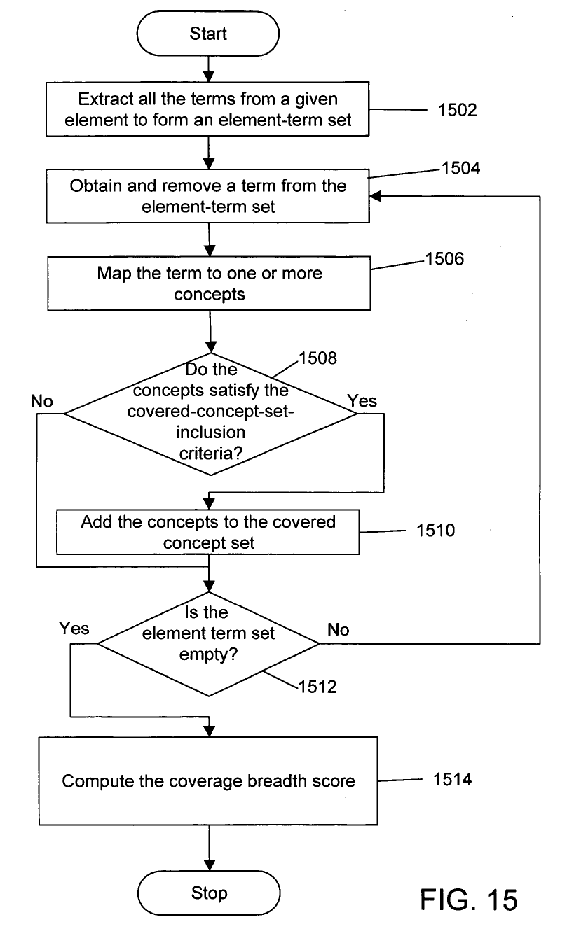

At step 1302, a coverage breadth score for the content element is computed. An embodiment for computing the coverage breadth score for a content element, based on the terms present in the content element has been described in detail in conjunction with FIG. 14. An embodiment for computing the coverage breadth score for a content element based on the concepts present in the content element has been described in detail in conjunction with FIG. 15.

At step 1304, a coverage depth score for the content element is computed. An embodiment for computing the coverage depth score for a content element based on the terms present in the content element has been described in detail in conjunction with FIG. 16. An embodiment for computing the coverage depth score for a content element, based on the concepts present in the content element has been described in detail in conjunction with FIG. 17.

At step 1306, an element-characteristic score is computed for the content elements. In an embodiment of the invention, the element-characteristic score for the content element is computed as a value inversely proportional to the size of the content element. In another embodiment of the invention, the element-characteristic score for the content element is computed as the ratio of the size of the content element to the number of outlinks contained in the content element. An outlink is defined as a hyperlink, which refers to a content element other than the content element for which the element-characteristic score is being computed.

At step 1308, an element importance score for the obtained content element is computed. In an embodiment of the invention, the element importance score for the content element is computed as the number of other content elements containing hyperlinks that refer to the content element, wherein the other content elements are content elements for which the element importance score is not being computed. Various methods are known in the art for computation of scores similar to an element importance score, such as the PageRank algorithm.

At step 1310, various subjective criteria related to the content element are evaluated. In an embodiment of the invention a subjective criteria may be to assign content element weights as specified by editors. For example, an editor may specify that web pages from certain websites should be given a preference over web pages from other websites.

In other embodiments of the invention, subjective criteria may comprise one or more criteria, such as, required terms that are specified by editors or other means, excluded terms that satisfy a set of term-set-pruning criteria, required concepts that are specified by editors or other means, excluded concepts that satisfy a set of concept-set-pruning-criteria, required content elements that satisfy a set of content-element-inclusion criteria, excluded content elements that satisfy a set of content-element-exclusion criteria, and item weightings.

At step 1312, a CoverageRank score is computed as a function of the Coverage Breadth Score, the Coverage Depth Score, the Element-characteristic score, the Element Importance Score and the subjective criteria computed in steps 1302, 1304, 1306, 1308 and 1310, respectively.

In an embodiment of the invention, the CoverageRank score is computed as the weighted sum of the coverage-breadth score, coverage-depth score, element- characteristics score, and element-importance score, multiplied by the content element weight assigned as the subject criteria.

It will be apparent to a person skilled in the art that various other factors may be included in the computation of the CoverageRank score of a content element. Further, innumerable functions may be devised to compute the CoverageRank score from the various factors included in the computation. The functions and factors described here, do not limit the scope of the invention and are described only as examples.

Step 1302 of FIG. 13 has been described in detail in conjunction with FIG. 14. An alternative embodiment of step 1302 has been described in detail in conjunction with FIG. 15.

FIG. 14 is a flowchart that represents a method for computing the coverage breadth score for a content element, according to an embodiment of the invention. The method comprises an iterative loop, wherein at each iteration, a term is removed from an element term set and added to a covered-term set, based on a set of pre-defined covered-term set-inclusion criteria. The covered-term set is the set of terms deemed to be covered by the content element. The iteration is continued until the element term set is empty.

At step 1402, all the terms from the content element are extracted to form an element term set. Further, a covered-term set is defined, initially containing no terms. At step 1404, a term is obtained and removed from the element term set.

At step 1406, it is checked whether the obtained term satisfies the pre-defined covered-term set-inclusion criteria, or not. In an embodiment of the invention, a covered-term set-inclusion criterion may be to include terms that are present in the CoverageSet. In another embodiment of the invention, a covered-term set-inclusion criterion may be to include terms with a term-importance score greater than a pre-defined threshold value.

At step 1406, if the obtained term satisfies the covered-term set-inclusion criteria, step 1408 is performed. At step 1408, the obtained term is added to the covered-term set. After step 1408, step 1410 is performed.

Further, at step 1406, if the obtained term does not satisfy the covered-term set-inclusion criteria, step 1410 is performed.

At step 1410, it is checked whether the element term set is empty, or not. If, at step 1410, the element term set is not empty, steps 1404, 1406, 1408, and 1410 are performed iteratively as a part of the loop, until the element term set is empty. If, at step 1410, the element term set is empty, the loop is terminated and step 1412 is performed. At step 1412, the coverage breadth score for the content element is computed, in a preferred embodiment, as the sum of the weights assigned to each term contained in the covered-term set.

FIG. 15 is a flowchart that represents a method for computing the coverage breadth score for a content element, according to another embodiment of the invention. The method comprises an iterative loop, wherein at each iteration, a term is removed from an element term set and mapped to one or more concepts. The one or more concepts are added to a covered-concept set, based on a set of pre-defined covered-concept-set-inclusion criteria. The iteration is continued until the element term set is empty.

At step 1502, all the terms from a content element are extracted to form an element term set. Further, a covered-concept set is defined, initially containing no elements.

At step 1504, a term from the element term set is obtained and removed from the element term set. At step 1506, the obtained term is mapped onto one or more concepts. Methods for mapping terms to concepts are known in the art.

At step 1508, it is checked whether the one or more concepts, to which the obtained term has been mapped, satisfy a set of pre-defined covered-concept-set-inclusion criteria, or not. In an embodiment of the invention, a covered-concept-set-inclusion criterion may be to include concepts that are present in the CoverageSet. In another embodiment of the invention, a covered-concept-set-inclusion criterion may be to include concepts with a concept-importance score greater than a pre-defined threshold value.

At step 1508, if the one or more concepts satisfy the set of covered-concept-set-inclusion criteria, step 1510 is performed. At step 1510, the one or more concepts that satisfy the set of covered-concept-set-inclusion criteria are added to the covered-concept set. After step 1510, step 1512 is performed. Further, at step 1508, if none of the concepts satisfy the covered-concept-set-inclusion criteria, step 1512 is performed.

At step 1512, it is checked whether the element term set is empty, or not. At step 1512, if the element term set is not empty, steps 1504, 1506, 1508, 1510 and 1512 are performed iteratively as part of the loop. At step 1512, if the element term set is empty, the iterative loop is terminated and step 1514 is performed. At step 1514, a coverage breadth score is computed as the sum of the weights assigned to each concept present in the covered-concept set.

FIG. 16 is a flowchart that represents a method for computing the coverage depth score for a content element, in accordance with an embodiment of the invention. First, the covered terms from the content element are extracted to form a covered-term set. The method includes an iterative loop, wherein at each iteration, a term is obtained and removed from a covered-term set. Based on a set of pre-defined set of term-depth criteria, coverage depth score computations are performed for the obtained term. The iteration continues until the covered-term set is empty. Before the computations of the coverage depth score are started, the coverage depth score is set to zero.

At step 1602, a term is obtained and removed from a covered-term set for a content element. The covered-term set includes all the covered terms present in the content element. In an embodiment of the invention, the covered-term set may be prepared by using the method for computing a covered-term set described in conjunction with FIG. 14.

At step 1604, a term frequency (t.f.) for the obtained term with respect to the content element is computed. In an embodiment of the invention, the term frequency for the obtained term with respect to the content element may be computed as the number of times the obtained term occurs in the content element. In another embodiment of the invention, the term frequency for the obtained term with respect to the content element is computed as the ratio of the number of times the obtained term occurs in the content element to the total number of terms in the content element.

At step 1606, an inverse document frequency (i.d.f.) for the obtained term is computed. In an embodiment of the invention, the inverse document frequency for the obtained term is computed as the logarithm of the ratio of the total number of content elements to the number of content elements in which the obtained term occurs.

At step 1608, a term-importance score for the obtained term is computed. In an embodiment, the term-importance score could be the pre-defined term weight in the CoverageSet.

At step 1610, it is checked whether the obtained term satisfies a set of pre-defined term-depth criteria, or not. In an embodiment of the invention, a term-depth criterion may be to include terms that are present in the CoverageSet. In another embodiment of the invention, a term-depth criterion may be to include terms for which a term-importance score is greater than a pre-defined threshold value.

At step 1610, if the set of term-depth criteria are satisfied by the obtained term, step 1612 is performed. At step 1612, in a preferred embodiment, the value of the coverage depth score for the content element is increased by the addition of the product of the term frequency and inverse document frequency, as computed in steps 1604 and 1606, respectively, weighted by the term weight associated with the obtained term to obtain an updated coverage depth score. After step 1612, step 1614 is performed. However, at step 1610, if the set of term-depth criteria are not satisfied by the obtained term, then step 1614 is performed.

At step 1614, it is checked whether the covered-term set is empty, or not. If the covered-term set is not empty, steps 1602, 1604, 1606, 1608, 1610, 1612, and 1614 are performed iteratively as a part of the loop. At step 1614, if the covered-term set is empty, the loop is terminated and computation of the coverage depth score for the content element is complete.

FIG. 17 is a flowchart that represents a method for computing the coverage depth score for a content element, in accordance with another embodiment of the invention. To begin with, terms from the content element are extracted and mapped to concepts to form a covered-concept set. The method includes an iterative loop, wherein at each iteration, a concept is obtained and removed from a covered-concept set. Based on a set of pre-defined concept-depth criteria, coverage depth score computations are performed for the obtained concept. The iteration continues until the covered-concept set is empty.

At step 1702, a concept is obtained and removed from a covered-concept set for a content element. The covered-concept set includes all the concepts present in the content element which have been covered. In an embodiment of the invention, the covered-concept set may be prepared by using the method for computing a covered-concept set described in conjunction with FIG. 15.

At step 1704, a concept frequency (c.f.) for the obtained concept, with respect to the content element, is computed. In an embodiment of the invention, the concept frequency for the obtained concept with respect to the content element is computed as the sum of the term frequencies of all the terms mapping onto the concept. For example, in a document containing the terms, cricket—three times, football—two times, and hockey—five times, wherein the three terms map to the concept ‘sports’, the concept frequency of the concept ‘sports’ would be ten.

At step 1706, an inverse document frequency (i.d.f.) for the obtained concept is computed. In an embodiment of the invention, the inverse document frequency for the obtained concept is computed as the logarithm of the ratio of the total number of content elements to the number of content elements in which the obtained concept occurs.

At step 1708, a concept-importance score for the obtained concept is computed.

At step 1710, it is checked whether a set of pre-defined concept-depth criteria are satisfied by the obtained concept, or not. In an embodiment of the invention, a concept-depth criterion may be to include concepts that are present in the CoverageSet. In another embodiment of the invention, a concept depth criterion may be to include concepts for which the concept-importance score is greater than a pre-defined threshold value.

At step 1710, if the set of concept-depth criteria are satisfied, step 1712 is performed. At step 1712, the coverage depth score is increased by the addition of the product of the concept frequency and the inverse document frequency, as computed in steps 1704 and 1706, respectively, weighted by the term weight associated with the obtained term to obtain the updated coverage depth score. After step 1712, step 1714 is performed. Further, if at step 1710, the set of concept depth criteria are not satisfied by the obtained concept, step 1714 is performed.

At step 1714, it is checked whether the covered-concept set is empty, or not. At step 1714, if the covered-concept set is not empty, steps 1702, 1704, 1706, 1708, 1710, 1712 and 1714 are performed iteratively, as a part of the loop. At step 1714, if the covered-concept set is empty, the loop is terminated and the coverage depth score for the content element is computed.

FIG. 18 is a schematic representation of summarizer 306 for forming a summary, according to an embodiment of the invention. Summarizer 306 comprises a CoverageSet managing module 1802, a CoverageRank computing module 1804, and a summary managing module 1806.

Summarizer 306 forms a summary from a corpus of content elements. This summary is prepared for a user of a device who has non-persistent network connectivity with various sources from which content elements may be obtained.

CoverageSet managing module 1802 is capable of extracting items from a content element, adding items to an item set, and removing items from an item set, computing the document frequency of an item in a set of content elements, counting the number of items in an item set, and determining whether an item set is empty. Examples of an item set are the CoverageSet, a covered-term set, a covered-concept set, and the like. Further, CoverageSet managing module 1802 is capable of assigning weights to items contained in a CoverageSet, assigning multiple coverage values to items contained in a CoverageSet, setting a maximum coverage value for items contained in a CoverageSet, pruning a CoverageSet based on CoverageSet-pruning criteria, and determining whether an item satisfies the CoverageSet-inclusion criteria, or not. Further, CoverageSet managing module 1802 is capable of mapping a term onto one or more concepts, and mapping a concept to one or more terms.

CoverageRank computing module 1804 computes the CoverageRank score of a content element, based on a CoverageSet generated by CoverageSet managing module 1802. CoverageRank computing module 1804 is capable of computing the coverage breadth score for a content element, computing the coverage depth score for a content element, computing the element-characteristic score for a content element, computing the element importance score for a content element, and evaluating the subjective criteria for a content element. Further, CoverageRank computing module 1804 is capable of computing the CoverageRank score, based on subjective criteria, as a function of the coverage breadth score, coverage depth score, element-characteristic score, and element importance score.

Summary managing module 1806 forms a summary, based on the CoverageRank scores computed by CoverageRank computing module 1804. Summary managing module 1806 is capable of forming a summary that may be delivered to a device belonging to a user, wherein the device has non-persistent network connectivity with the various sources from which content elements may be obtained. Summary managing module 1806 is also capable of setting and removing the added flag and excluded flag associated with content elements in the corpus.

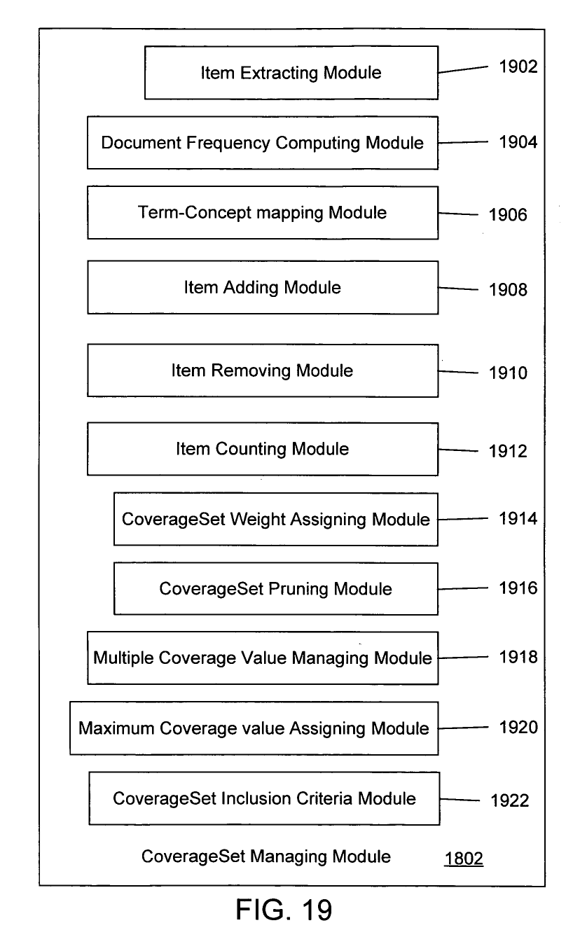

FIG. 19 is a schematic representation of CoverageSet managing module 1802, according to an embodiment of the invention. CoverageSet managing module 1802, comprises an item extracting module 1902, a document frequency computing module 1904, a term-concept mapping module 1906, an item adding module 1908, an item removing module 1910, an item counting module 1912, a CoverageSet weight assigning module 1914, a CoverageSet pruning module 1916, a multiple coverage value managing module 1918, a maximum coverage value assigning module 1920, a CoverageSet inclusion criteria module 1922.

Item extracting module 1902 is capable of extracting items from a content element. Document frequency computing module 1904 is capable of computing the document frequency of an item in a set of content elements. Term-concept mapping module 1906 is capable of mapping a term to one or more concepts and mapping a concept to one or more terms. Item adding module 1908 is capable of adding items to an item set. Item removing module 1910 is capable of removing items from an item set. Item counting module 1912 is capable of counting the number of items in an item set and determining whether an item set is empty, or not. CoverageSet weight assigning module 1914 is capable of assigning weights to items contained in a CoverageSet. CoverageSet pruning module 1916 is capable of pruning a CoverageSet based on CoverageSet pruning criteria. Multiple coverage value managing module 1918 is capable of assigning multiple coverage values to items contained in a CoverageSet. Maximum coverage value assigning module 1920 is capable of setting a maximum coverage value for items contained in a CoverageSet. CoverageSet inclusion criteria module 1922 is capable of determining whether an item satisfies the CoverageSet inclusion criteria, or not.

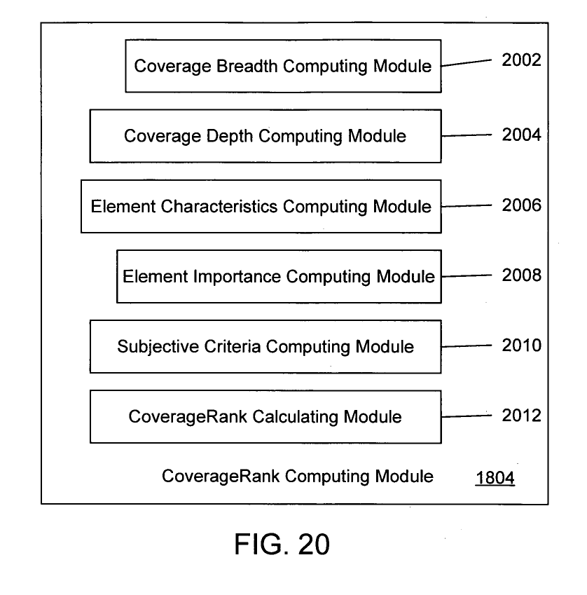

FIG. 20 is a schematic representation of CoverageRank computing module 1804, according to an embodiment of the invention. CoverageRank computing module 1804 comprises a coverage breadth computing module 2002, a coverage depth computing module 2004, an element characteristics computing module 2006, an element importance computing module 2008, a subjective criteria computing module 2010, a CoverageRank calculating module 2012.

Coverage breadth computing module 2002 is capable of computing the coverage breadth score of a content element. Coverage depth computing module 2004 is capable of computing the coverage depth score of a content element. Further, coverage depth computing module 2004 is capable of computing the item frequency for an item in a content element, computing the item importance score for an item, computing the inverse document frequency for an item with respect to a set of content elements, determining whether an item satisfies the item depth criteria, and aggregating the coverage depth score of an item with the overall coverage depth score of a content element.

Element characteristics computing module 2006 is capable of computing the element-characteristic score for a content element. Element importance computing module 2008 is capable of computing the element importance score for a content element. Subjective criteria computing module 2010 is capable of evaluating the subjective criteria for a content element. CoverageRank calculating module 2012 is capable of computing the CoverageRank score, based on subjective criteria, as a function of the coverage breadth score, coverage depth score, element characteristics score, and element importance score.

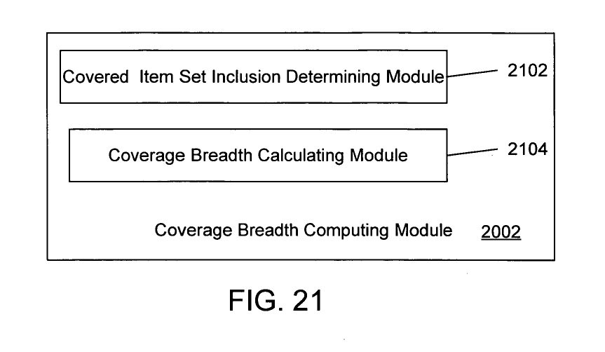

FIG. 21 is a schematic representation of coverage breadth computing module 2002, in accordance with an embodiment of the invention. Coverage breadth computing module 2002 comprises a covered item set inclusion determining module 2102 and a coverage breadth calculating module 2104. Covered item set inclusion determining module 2102 is capable of determining whether an item is satisfying the pre-defined covered item set inclusion criteria, or not. Coverage breadth calculating module 2104 is capable of calculating the coverage breadth of a content element as the number of items present in a covered item set, related to the content element.

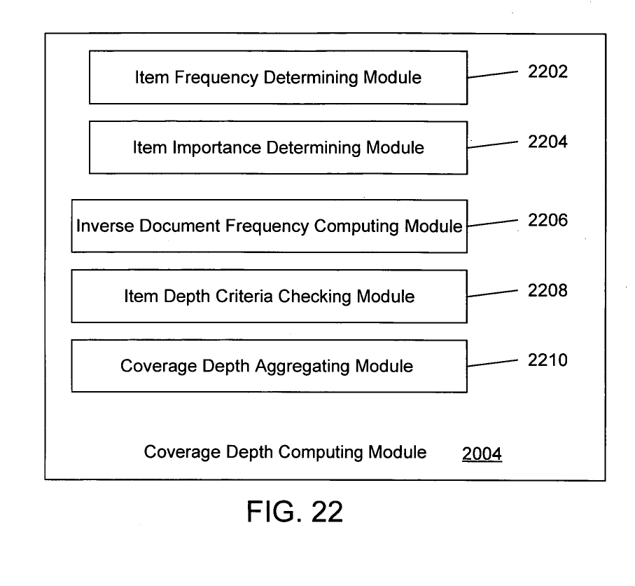

FIG. 22 is a schematic representation of coverage depth computing module 2004, according to an embodiment of the invention. Coverage depth computing module 2004 comprises an item frequency determining module 2202, an item importance determining module 2204, an inverse document frequency computing module 2206, an item depth criteria checking module 2208, and a coverage depth aggregating module 2210. Item frequency determining module 2202 is capable of computing the item frequency for an item in a content element. Item importance determining module 2204 is capable of computing the item importance score for an item. Inverse document frequency computing module 2206 is capable of computing the inverse document frequency for an item with respect to a set of content elements. Item depth criteria checking module 2208 is capable of determining whether an item satisfies item depth criteria or not. Coverage depth aggregating module 2210 is capable of aggregating the coverage depth score of an item to the overall coverage depth score of a content element.

Steps of flowcharts from FIG. 5 to FIG. 17 may be performed by relevant system elements represented in FIGS. 18 to 22, details regarding which are provided below.

In an embodiment of the invention, step 502 is performed by item adding module 1908; step 506 is performed by CoverageRank computing module 1804; step 508 is performed by summary managing module 1806; step 510 is performed by item removing module 1910; and step 512 is performed by item counting module 1912.

In an embodiment of the invention, step 602 is performed by item adding module 1908; step 606 is performed by CoverageRank computing module 1804; step 608 is performed by summary managing module 1806; step 610 is performed by multiple coverage value managing module 1918; step 612 is performed by item removing module 1910; and step 614 is performed by item counting module 1912.

In an embodiment of the invention, step 702 is performed by item extracting module 1902; and step 704 is performed by item adding module 1908.

In an embodiment of the invention, step 802 is performed by item extracting module 1902; step 804 is performed by term-concept mapping module 1906; and step 708 is performed by item adding module 1908.

In an embodiment of the invention, step 902 is performed by item extracting module 1902 and item adding module 1908; step 904 is performed by document frequency computing module 1904; step 906 is performed by CoverageSet weight assigning module 1914; step 908 is performed by CoverageSet pruning module 1916; step 910 is performed by multiple coverage value managing module 1918; and step 912 is performed by maximum coverage value assigning module 1920.

In an embodiment of the invention, step 1002 is performed by item extracting module 1902 and item adding module 1908; step 1004 is performed by document frequency computing module 1904; step 1006 is performed by CoverageSet weight assigning module 1914; step 1008 is performed CoverageSet pruning module 1916; step 1010 is performed by multiple coverage value managing module 1918; and step 1012 is performed by maximum coverage value assigning module 1920.

In an embodiment of the invention, steps 1102 and 1104 are performed by summary managing module 1806.

In an embodiment of the invention, steps 1202 and 1203 are performed by summary-managing module 1806; step 1204 is performed by item-extracting module 1902; step 1204 is performed by coverage-depth-computing module 2004; step 1208 is performed by summary-managing module 1806; and step 1210 is performed by item-counting module 1912.

In an embodiment of the invention, step 1302 is performed by coverage breadth computing module 2002; step 1304 is performed by coverage depth computing module 2004; step 1306 is performed by element characteristics computing module 2006; step 1308 is performed by element importance computing module 2008; step 1310 is performed by subjective criteria computing module 2010; and step 1312 is performed by CoverageRank calculating module 2012.

In an embodiment of the invention, step 1402 is performed by item-extracting module 1902; step 1404 is performed by item-removing module 1910; step 1406 is performed by covered item set inclusion-determining module 2102; step 1408 is performed by item-adding module 1908; step 1410 is performed by item-counting module 1912; and step 1412 is performed by coverage-breadth-calculating module 2104.

In an embodiment of the invention, step 1502 is performed by item extracting module 1902; step 1504 is performed by item removing module 1910; step 1506 is performed by term-concept mapping module 1906; step 1508 is performed by covered item set inclusion determining module 2102; step 1510 is performed by item adding module 1908; step 1512 is performed by item counting module 1912; and step 1514 is performed by coverage breadth calculating module 2104.

In an embodiment of the invention, step 1602 is performed by item removing module 1910; step 1604 is performed by item frequency determining module 2202; step 1606 is performed by inverse document frequency computing module 2206; step 1608 is performed by item importance determining module 2204; step 1610 is performed by item depth criteria checking module 2208; step 1612 is performed by coverage depth aggregating module 2210; and step 1614 is performed by item counting module 1912.

In an embodiment of the invention, step 1702 is performed by item removing module 1910; step 1704 is performed by item frequency determining module 2202; step 1706 is performed by inverse document frequency computing module 2206; step 1708 is performed by item importance determining module 2204; step 1710 is performed by item depth criteria checking module 2208; step 1712 is performed by coverage depth aggregating module 2210; and step 1714 is performed by item counting module 1912.

Content available on the Internet, intranets of various organizations, and other sources may be under the process of being regularly updated. For a user with a device having non-persistent network connectivity, it will be apparent that a one-time delivery of a summary to the user's device may not be enough for a satisfactory user experience. It is, therefore, essential to deliver fresh and up-to-date content elements to clients present on devices.

However, certain content elements available from some sources are updated more frequently than others. For example, a webpage related to American political news will be updated more frequently than a webpage related to the history of the American Revolution. According to another example, a webpage related to weather forecasts will be updated more frequently than a webpage related to an article about data-compression techniques. As per another example, a sound file containing a speech of Martin Luther King Jr., will not be updated at all.

Therefore, it is apparent that there is a need to classify content elements so that the content elements can be delivered to a client present in a user's device, in an efficient manner. In an embodiment of the invention, each content element may be designated as belonging to one of the following classes: slow web, fast web, and personal web.

A content element belonging to the slow web category indicates that the content element is not updated frequently and has relatively high item coverage. An example of a content element belonging to the slow web category may be an encyclopedia available on the Internet that covers a large number of items but is updated relatively infrequently. Another example of a content element belonging to the slow web category may be an e-book that covers a large number of items in a particular domain with the frequency of changes to the e-book being very low.

A content element belonging to the fast web category indicates that the content element is updated frequently. An example of a content element belonging to the fast web category may be news stories that are updated relatively frequently, such as on a daily, weekly or fortnightly basis. Another example of a content element belonging to the fast web may include weather forecasts that need to be changed very frequently, such as on an hourly basis.

A content element belonging to the personal web category indicates that the content element is relevant to the user. Embodiments of a method for forming a user profile that may be used to determine content elements of relevance or interest to the user, have been described in detail, in conjunction with FIGS. 22 and 26. An example of a content element belonging to the personal web category may be a web page containing information about tourist places of interest to the user. Another example of a content element belonging to the personal web category may be a web page containing information about birds, if the user is interested in ornithology.

In an embodiment of the invention, each content element included in the summary may be delivered individually to the clients. However, the summary may comprise thousands of content elements. In order to make an efficient and effective delivery of a summary to clients, a number of logically-related content elements are packaged together into a content block, wherein each content block is delivered to the clients as a single entity. This facilitates the update servers as well as the clients to manage and update the content elements effectively.

In an embodiment of the invention, all content elements contained in a summary are packaged together into a content block. In another embodiment of the invention, content elements contained in a summary are packaged separately into one or more content blocks. In another embodiment, multiple summaries may be packaged together into a content block. Therefore, in various embodiments of the invention, a package delivered to the client may include multiple, single or partial summaries.

In yet another embodiment of the invention, content elements contained in a content block are selected from a process other than summarization, as described above. According to an example, all web pages from a particular domain are packaged together into one content block. According to another example, all songs by the rock band ACDC are packaged together into one content block.

FIG. 23 is a schematic representation of a content block, according to an embodiment of the invention. A content block 2300 comprises a plurality of content elements 2302, subject tags 2304, 2306, and 2308, a timestamp tag 2310, a block identifier 2312, one or more personal tags 2314, and an index 2316.

Subject tags 2304, 2306 and 2308 identify the various topics being described or covered in content elements 2302. In an embodiment of the invention, subject tags 2304, 2306, and 2308 store alphanumeric strings identifying the topics described in content elements 2302. In another embodiment of the invention, subject tags 2304, 2306, and 2308 store subject codes, each subject code being assigned a pre-defined topic. For example, content elements 2302 are web pages describing the various aspects of how the game of cricket is played. Subject tags 2304 and 2306 contain the alphanumeric strings ‘cricket’ and ‘sport’, respectively.

According to another example, content elements 2302 are web pages containing news about cricket. Subject tags 2304, 2306, and 2308 contain the alphanumeric strings ‘cricket’, ‘sport’, and ‘news’, respectively.

According to yet another example, content elements 2302 are web pages containing journal articles about nanotechnology. Subject tags 2304, 2306, and 2308 contain the alphanumeric strings ‘science’, ‘nanotechnology’, and ‘journal articles’, respectively.

According to another example, content elements 2302 are images related to various tourist attractions in India. Subject tags 2304 and 2306 contain the subject descriptor ‘tourist attractions’ and ‘India’, respectively.

According to another example, content elements 2302 are sound recordings of famous speeches. Subject tag 2302 contains the alphanumeric string ‘famous speeches’.

It will be apparent to a person skilled in the art that a content element can have zero or more subject tags.

Timestamp tag 2310 is used to store the following information related to content block 2300: date, time and frequency of formation, and other relevant information. For example, content block 2300 is formed at 0000 hours on the first day of each month. Therefore, for a content block formed at 0000 hours on Aug. 01, 2005, the timestamp tag 2310 will contain the date of formation as August 01, 2005; time of formation as 0000 hours; and the frequency of formation as ‘monthly’.

In another example, content block 2300 is formed every day at midnight. Therefore, for a content block formed at 0000 hours on Sep. 01, 2005, the timestamp tag 2310 will contain the date of formation as Sep. 01, 2005; time of formation as 0000 hours; and the frequency of formation as ‘daily’.

It will be apparent to a person skilled in the art that a content element can have zero or more timestamp tags.

Block identifier 2312 is used to identify content block 2300. In an embodiment of the invention, content blocks, which are mutually neutral, are assigned the same block identifier. If a plurality of content blocks is mutually neutral, it means that the content elements contained within each of the content blocks are logically related. For instance, two cache blocks that are prepared on a monthly basis, each containing different content elements related to Indian history, with one prepared at the end of February, and the other prepared at the end of March, will still have the same block identifier.

Personal tags 2314 are used to indicate whether the content block 2300 is a personalized block or not. The concept of personalizing updates is described in details in conjunction with FIGS. 25 and 26.

Index 2318 stores a mapping of all the items covered by content elements contained in the block with the content elements covering those items. This index is used by software stored in the device for searching content elements stored in the content blocks.

Further, it will be apparent to a person skilled in the art that a content block may be organized employing various data structures known in the art.

Packager 308 prepares content blocks. The process of preparing a content block includes associating various subject tags, personal tags, and timestamp tags with the content block; associating a block identifier with the content block; and preparing and associating an index with the content block. In an embodiment of the invention, the process of preparing a content block may also include compressing the content block to reduce its size. Various methods known in the art for compression may be employed to compress content blocks.

FIGS. 24a and 24b represent a flowchart of a method to update content blocks cached on a device, according to an embodiment of the invention. The method includes an iterative loop, wherein at each iteration, a list entry is obtained and removed from a required content blocks list. The content block is identified by the obtained list entry, and is updated, based on a set of pre-defined criteria. The iteration is continued until the required content blocks list is empty.

At step 2402, a device establishes a connection with an update server. At step 2404, the device sends its identification information to the update server. In an embodiment of the invention, the device identification information may include a list of block identifiers for all content blocks cached on the device. In another embodiment of the invention, the identification information of the device may be associated with a user profile stored on the update server. In another embodiment of the invention, the device identification itself may contain the user profile, including a user-item set. The user profile contained in the device identification may be used to update the user profile stored in the update server. The user profile may be used to deliver content elements of interest to the user. A user-item set contains items which have been inferred to be of interest to the user. An embodiment of a method for creating a user-item set has been described in conjunction with FIG. 25.

On the basis of the device identification information sent by the device, the update server prepares and sends a required content blocks list. The required content blocks list comprises a list of entries, wherein each list entry identifies a content block that should be contained in the cache of the device after the update process is complete. In an embodiment of the invention, a list entry identifies a content block by specifying the block identifier and timestamp tag assigned to the content block.

At step 2406, the device receives the list of required content blocks from the update server. At step 2408, a list entry from the required content block list is obtained and removed from the required content blocks list.

At step 2410, it is checked whether any content block contained in the device cache has the same block identifier as that specified by the obtained list entry. If there is no content block with the same block identifier, step 2412 is performed. At step 2412, the content block identified by the obtained list entry is retrieved from the update server and cached on the device. Thereafter, step 2414 is performed. At step 2414, it is checked whether the required content blocks list is empty. If, at step 2414, the required content blocks list is not empty, steps 2408, 2410, 2412, 2414, 2416, 2418 and 2420 are performed iteratively as a part of the loop. If, at step 2414, the required content blocks list is empty, the loop is terminated and the update process is complete.

If, at step 2410, a content block with the same block identifier is cached on the device, step 2416 is performed. At step 2416, it is checked whether the content block identified by the obtained list entry is newer than the corresponding content block cached on the device. In an embodiment of the invention, this is carried out by comparing the timestamp tag of the content block cached on the device with the timestamp tag specified by the obtained list entry. If the content block identified by the obtained list entry is newer, step 2418 is performed. At step 2418, the content block identified by the obtained list entry is retrieved from the update server and cached on the device. At step 2420, the older content block is deleted from the device cache. Thereafter, step 2414 is performed. Further, if at step 2416, the content block identified by the obtained list entry is older than the corresponding content block cached on the device, step 2414 is performed.

At step 2414, it is checked whether the required content blocks list is empty. If, at step 2414, the required content blocks list is not empty, steps 2408, 2410, 2412, 2414, 2416, 2418 and 2420 are performed iteratively. If, at step 2414, the required content blocks list is empty, the loop is terminated and the update process is complete.

It is essential to deliver content elements, which are relevant and of interest to the user. Therefore, it will be apparent that delivering the same summary to all the users is not a satisfactory experience for all users. For identifying content elements that are relevant and relate to the interests of a user, it is necessary to create and modify a profile for each user. From the user profile, a user-item set may be created, which represents the areas of interest of the user. Content elements covering the items contained in the user-item set are then delivered to the user.

An embodiment of a method for creating and modifying a user profile has been described in detail, in conjunction with FIGS. 22 and 23.

FIG. 25 is a schematic representation of a system 2500 for creating and modifying a user profile, and creating a user-item set, in according to an embodiment of the invention.

The system comprises zero or more personal computers 2502, devices 206, zero or more information-containing electronic devices 2504, zero or more servers 2506, a user-profiling module 2508, a user profile storage area 2510, a user item set creating module 2512, and a user item set 2514.

Examples of information-containing electronic devices 2504 include, but are not limited to, electronic devices such as a mobile phone, a television, a refrigerator, a microwave oven, and other such devices known in the art. These devices may contain information that is related to the user.

User profiling module 2508 is a personal information mining means. User-profiling module 2508 is a software module that obtains personalized information of a user of device 208 from various resources available on personal computers 2504, devices 206, information-containing electronic devices 2504, and servers 2206. Further, user-profiling module 2208 explicitly requests terms of interest from the user.

Examples of personalized information include, but are not limited to, preferred language of the user, personal interests of the user, demographic details of the user, and the like. Examples of the various resources include, but are not limited to, e-mails, call logs, browser history, search history, documents of the user, and the like.

User profile storage area 2510 stores a user's personalized information obtained by user-profiling module 2508. Examples of user profile storage area 2510 include, but are not limited to, memory devices like hard disk, random access memory (RAM), storage server and other such devices known in the art.

User item set creating module 2512 analyzes the various resources stored in user-profile storage area 2510, to generate a user-item set 2514 containing items of interest to the user. In an embodiment of the invention, the user-item set is created by extracting unique items in the resources stored in the user profile storage area.

In an embodiment of the invention, the personal information of the user is analyzed to determine one or more geographical locations of interest to the user. A method for determining geographical locations of interest to the user includes determining geographical locations mentioned in calendar entries or travel plans of the user. Another method for determining geographical locations of interest to the user, wherein device 206 is equipped with a Global Positioning System (GPS), includes tracking the history of GPS locations of device 206. Yet another method for determining geographical locations of interest to the user includes using cellular triangulation. Still another method for determining geographical locations of interest to the user, wherein device 206 is equipped with an RFID chip, includes tracking the RFID signals emitted by the RFID chip.

FIG. 26 is a flowchart representing a method for creating and modifying a user profile, and creating a user-item set, in accordance with an embodiment of the invention.

At step 2602, personalized information of a user of the device is obtained from the various resources available on personal computers, devices, information-containing electronic devices, and servers. Further, the personalized information may be obtained by explicitly requesting terms of interest from the user. In an embodiment of the invention, user profile obtaining module 2408 performs step 2602.

At step 2604, the personalized information is stored in a user profile storage area. In an embodiment of the invention, user profile obtaining module 2408 stores the personalized information in user profile storage area 2410.

At step 2606, important items are extracted from the personal information stored on the user-profile storage area, based on a set of pre-defined user set inclusion criteria, to form a user-item set. In an embodiment of the invention, a user set inclusion criterion may be to include items with a document frequency greater than a pre-defined threshold value. In another embodiment of the invention, a user set inclusion criterion may be to include items explicitly specified by the user. In an embodiment of the invention, user-item set creating module 2412 performs step 2606 to create user-item set 2414.

The present invention enables a user with a device that has a non-persistent connectivity, to perform transactions over the Internet, anytime and anywhere. These transactions are carried out between a transaction server and the user's device. The details of services that can be provided by the transaction server are stored on the device of the user. The user may perform transactions in the absence of any network connectivity between the device and the transaction server. Further, the user is able to store the details of the transactions in a cache of the device. The device may communicate the details of the transaction to the transaction server at a later point of time, when the connectivity of the mobile device to the transaction server is re-established. FIGS. 24 and 25 describe the enablement of commercial transactions between the transaction server and the user's device, without a real-time connection to the Internet, in accordance with an embodiment of the present invention.

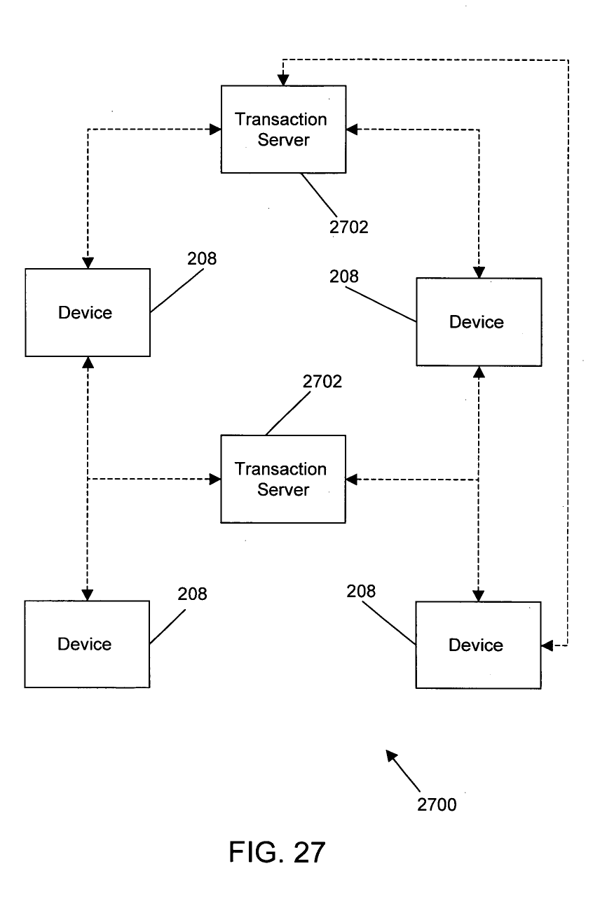

FIG. 27 illustrates an exemplary environment 2700, for enabling commercial transactions without a real-time connection to the Internet, in accordance with an embodiment of the present invention. Environment 2700 includes devices 208 and a plurality of transaction servers 2702.

Each transaction server 2702 is a server capable of providing one or more different kinds of services to a user of device 208 connected to transaction server 2702. In an embodiment of the invention, the service provided by transaction server 2702 includes enabling the user to purchase articles offered for sale. In another embodiment of the invention, the service provided by transaction server 2702 includes enabling the user to buy and sell products to other users connected to transaction server 2702. In yet another embodiment of the invention, the service provided by transaction server 2702 includes enabling the user to perform banking and financial transactions.

Each device 208 is connected to one or more transaction servers 2702 through a non-persistent connection. Examples of a non-persistent connection between devices 208 and corresponding transaction servers 2702 include, but are not limited to, an infrared communication link, a Bluetooth communication link, a WiFi communication link, a USB link, and other such communication links known in the art.

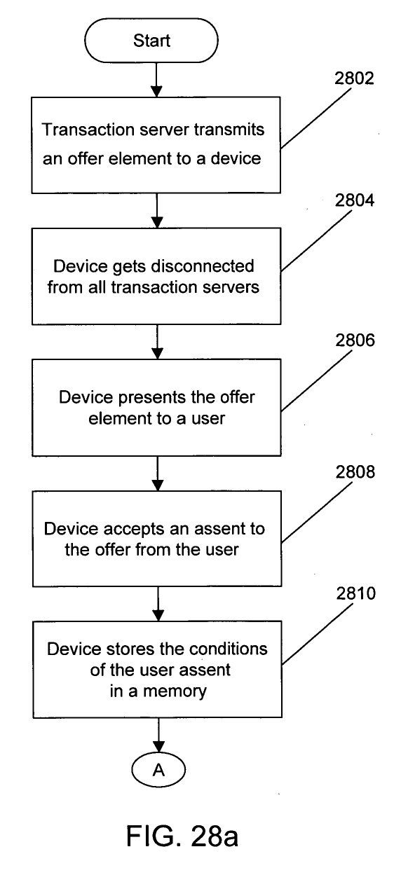

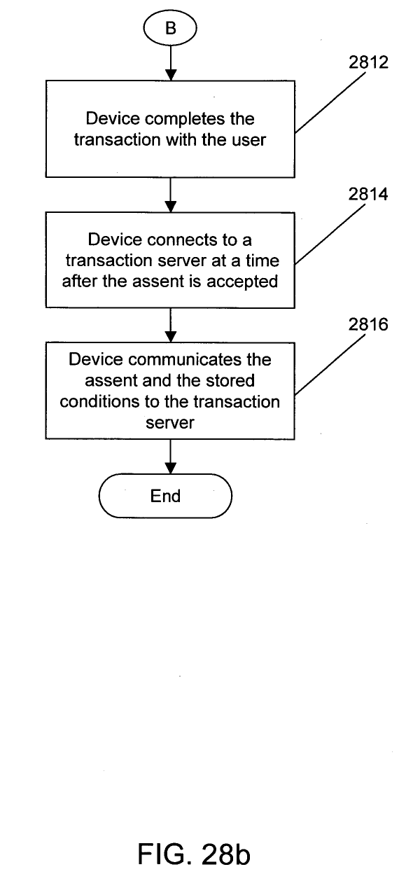

FIG. 28a and 28b are flowcharts representing a method for enabling commercial transactions without a real-time connection to the Internet, in accordance with an embodiment of the present invention. The user is capable of performing commercial transactions, using a device connected to a transaction server through non-persistent connectivity.

At step 2802, the transaction server transmits an offer element to the device, wherein the offer element is an offer of the one or more services provided by the transaction server to the user, along with the details about the service.

In an embodiment of the invention, the details about the service may include the price of the service, the date up to which the price is valid, location of the service, other offers applicable to the service and the like.

In another embodiment of the invention, the offer element may include details of a product, along with a time-dependent price. For example, a book may be offered for sale with a price of two dollars if purchased two hours from the time when the offer was first made, four dollars up to one day thereafter, and eight dollars up to one week thereafter, after which the validity of the offer element expires.

In yet another embodiment of the invention, the offer element may be a catalog of books for sale, including one or more details about the books.

At step 2804, the device is disconnected from all transaction servers. At step 2806, the offer element is presented to the user accessing the device.

At step 2808, the device accepts an assent to the offer from the user. The assent is accompanied by information related to the offer that the user needs to provide before giving the assent to the offer. In an embodiment of the invention, information along with the user's assent includes, but is not limited to, the details of the items selected by the user for purchase, the user's credit card details and the like.

At step 2810, the device stores the information provided with the user's assent, in a memory associated with the device. Examples of the memory include, but are not limited to, a random access memory (RAM), a hard disk drive, a flash drive, and other such devices known in the art. In an embodiment of the invention, the user may go ahead to obtain the service after the completion of the transaction.

At step 2812, the device completes the transaction with the user after confirming that all the requests for services by the user have been completed. At step 2814, the device gets connected to the transaction server after the device accepts the assent. At step 2816, the device communicates the assent and the stored information to the transaction server.

In an embodiment of the invention, the information required by the user may include the nature of the transaction that the user wishes to perform, wherein the nature of the transaction may either be an instant-commit transaction or a pending- commit transaction. An instant-commit transaction once performed is not revocable, i.e., even though the details of the transaction may not have been communicated to the transaction server, the user is not allowed to cancel or modify the transaction. However, in case of a pending-commit transaction, the user may cancel or modify the details of the transaction before the details are communicated to the transaction server. In an embodiment of the invention, a user may perform an instant-commit transaction on the device, following which, the user may be provided with a specially designed transaction identification number. The user may then obtain the purchased product from a store after the store merchant has verified the transaction identification number.

The various embodiments of the present invention exemplify the following advantages. The methods and systems described in the present invention enable a user of a device to access, browse and search the Internet anytime, anywhere, independently of connectivity of the user's device to the Internet. Further, the methods and systems of the present invention enable the user to access, browse and search Internet resources cost-effectively and at a reasonable speed, thereby providing a better user experience.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. Computer comprises a microprocessor. Microprocessor is connected to a communication bus. Computer also includes a memory. Memory may include random access memory (RAM) and read only memory (ROM). Computer system further comprises storage device. It can be a hard disk drive or a removable storage drive such as a floppy disk drive, optical disk drive and the like. Storage device can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

While the invention has been described in its preferred embodiments, it is to be understood that the words which have been used are words of description rather than of limitation and that changes may be made within the purview of the appended claims without departing from the true scope and spirit of the invention in its broader aspects. Rather, various modifications may he made in the details within the scope and range of equivalents of the claims and without departing from the spirit of the invention. The inventors further require that the scope accorded their claims be in accordance with the broadest possible construction available under the law as it exists on the date of filing hereof and that no narrowing of the scope of the appended claims be allowed due to subsequent changes in the law, as such a narrowing would constitute an ex post facto adjudication, and a taking without due process or just compensation.

What is claimed is:

1. A system for delivering Internet-derived content on a Device not having a persistent connection to the internet comprising means for enabling a user to browse or search a cache which is a small, representative subset of Internet-derived content elements on the Device, means for updating the cache at selected times by incrementally replacing some of the content stored in the cache, and means for controlling the update by relating the update process to the user's stored profile.

2. The system of claim 1 wherein the each element of cached content is designated as a member of a group selected from the categories of Slow Web, Fast Web, and Personal Web, where Slow Web denotes content that is infrequently updated and has relatively high term coverage;
Fast Web denotes content that is updated frequently; and
Personal Web denotes content relevant to a user profile.

3. The system of claim 1 further comprising Crawler means for traversing the Internet and copying content onto temporary storage means, Summarizer means for analysing the copied content to select that content that is to be placed into the device cache, Update Server means for delivering selected content to one or more Clients, which are connected to the Update Server using a connection having total bandwidth equal or greater than that of the Device.

4. A method of forming a small, representative subset of content selected from a plurality of sources comprising,
determining a coverage set comprising a set of terms to be included in the subset of content;
computing a CoverageRank score for each element of content; and
identifying those elements having membership in the subset by application of predefined membership criteria.

5. The method of claim 4 wherein the CoverageRank score is computed by the steps comprising,
determining the Coverage Breadth of a content element;
determining the Coverage Depth of a content element;
determining the element characteristics, including the degree of independence of the
element;
determining the importance of the element;
evaluating subjective criteria about each element, if present; and
computing CoverageRank as a function of Coverage Breadth, Coverage Depth, element characteristics, element importance and subjective criteria.

6. The method of claim 4 wherein the CoverageRank is, at least in part, based upon the meaning of terms within an element of content.

7. The method of claim 5 wherein subjective criteria comprise at least one of
required terms;
required term meanings;
required elements;
excluded terms;
excluded elements; and
term weightings.

8. The method of claim 5 wherein CoverageSet is, at least in part, based upon a domain-specific dictionary, related to a predetermined knowledge domain of interest to a user.

9. The method of claim 5 wherein the CoverageSet is, at least in part, based upon a set of terms excluding a set of terms predetermined to have a lower information value than the remaining terms.

10. The system of claim 1 wherein the cache of content elements is divided into blocks, and each block of cached content has associated therewith one or more subject tags, and wherein the set of all blocks having a common subject tag is updated during a single update session.

11. The system of claim 1 wherein each element of cached content has associated therewith one or more timestamp tags, and wherein the set of all elements having a common timestamp tag is updated during a single update session.

12. The system of claim 2 wherein membership of cached content in the Personal Web Category is determined with reference to the stored user profile.

13. The system of claim 12 wherein the stored user profile is modified by personal information mining means for identifying personalized information stored on at least one of (a) stored on the user's personal computer; (b) stored on the Device and (c) stored on electronic devices used by the user for storage of information; (d) stored on servers accessible to the user; and (e) a memory, as a result of one or more explicit responses by the user to one or more requests for terms.

14. The system of claim 12 wherein at least some elements in the Personal Web category are located by determining one or more geographic locations of interest to the user, locating internet content relevant to those locations, and placing the located elements into the cache.

15. The system of claim 14 wherein at least one geographic location is derived from a GPS, a cellular triangulation, a calendar entry, or an RFID signal.

16. A method for enabling commercial transactions using devices without a real-time connection to a transaction server comprising the steps of:
transmitting an offer element from a transaction server to a device;
disconnecting the device from all transaction servers; and then
presenting the offer element to a user;
accepting from the user an assent to the offer;
storing the conditions of the user assent in a memory;
completing the transaction with the user;
connecting the device to a transaction server at a time after accepting the assent; and
communicating the assent and the stored conditions to the transaction server.
